(19) United States
(12) Patent Application Publication
(10) Pub. No.: US 2008/0161499 A1
(43) Pub. Date: Jul. 3, 2008

(54) Water Swellable Material

(75) Inventors: Ulrich Riegel, Landstuhl (DE); Thomas Daniel, Waldsee (DE); Stefan Bruhns, Mannheim (DE); Mark Elliott, Ludwigshafen (DE); Bruno Johannes Ehrnsperger, Mason, OH (US); Stephen Allen Goldmann, Cincinnati, OH (US); Renae Fossum, Middletown, OH (US); Matthias Schmidt, Idstein (DE); Axel Meyer, Frankfurt (DE)

Correspondence Address: CONNOLLY BOVE LODGE & HUTZ, LLP, P O BOX 2207, WILMINGTON, DE, 19899, US

(73) Assignee: Basf Aktiengesellschaft, Ludwigshafen (DE)

(21) Appl. No.: 11/815,232

(22) PCT Filed: Feb. 3, 2006
(86) PCT No.: PCT/EP06/50662

§ 371 Date: Aug. 1, 2007

Related U.S. Application Data
(60) Provisional application No. 60/649,539, filed on Feb. 4, 2005.

(51) Int. Cl. C08F 283/06

(52) U.S. Cl. 525/326.1

(57) ABSTRACT

This invention relates to improved water-swellable material that can significantly withstand deformation by an external pressure, thus showing improved liquid handling properties. In particular, this invention relates to water-swellable material with an improved absorbent capacity/permeability balance. This invention also relates to a water-swellable material, comprising water-swellable polymers and elastomeric polymers, said material being typically in the form of particles, which comprise a core of water-swellable polymer(s) and a shell of said elastomeric polymer(s), whereby the water-swellable material is such that it can withstand deformation due to external pressure. The invention also relates to a specific process of making the specific water-swellable material of the invention.

### RELATED APPLICATIONS

This application is a national stage application (under 35 § U.S.C. 371) of PCT/EP2006/050662, filed Feb. 3, 2006, which claims benefit of U.S. Provisional application 60/649,539, filed Feb. 4, 2005.

This invention relates to improved water-swellable materials that can significantly withstand deformation by an external pressure, thus showing improved liquid handling properties. In particular, this invention relates to water-swellable materials with an improved absorbent capacity/permeability balance.

This invention also relates to a water-swellable material, comprising water-swellable polymers and elastomeric polymers, said material being typically in the form of particles, which comprise a core of water-swellable polymer (s) and a shell of said elastomeric polymer(s), whereby the water-swellable material is such that it can withstand deformation due to external pressure. The invention also relates to a specific process of making the specific water-swellable material of the invention.

An important component of disposable absorbent articles such as diapers is an absorbent core structure comprising water-swellable polymers, typically hydrogel-forming water-swellable polymers, also referred to as absorbent gelling material, AGM, or super-absorbent polymers, or SAP's. This polymer material ensures that large amounts of bodily fluids, e.g. urine, can be absorbed by the article during its use and locked away, thus providing low rewet and good skin dryness.

Especially useful water-swellable polymers or SAP's are often made by initially polymerizing unsaturated carboxylic acids or derivatives thereof, such as acrylic acid, alkali metal (e.g., sodium and/or potassium) or ammonium salts of acrylic acid, alkyl acrylates, and the like in the presence of relatively small amounts of di- or poly-functional monomers such as N,N′-methylenebisacrylamide, trimethylolpropane triacrylate, ethylene glycol di(meth)acrylate, or triallylamine. The di- or poly-functional monomer materials serve to lightly cross-link the polymer chains thereby rendering them water-insoluble, yet water-swellable. These lightly crosslinked absorbent polymers contain a multiplicity of carboxylate groups attached to the polymer backbone. It is generally believed, that the neutralized carboxylate groups generate an osmotic driving force for the absorption of body fluids by the crosslinked polymer network.

In addition, the polymer particles are often treated as to form a surface cross-linked layer on the outer surface in order to improve their properties in particular for application in baby diapers.

Water-swellable (hydrogel-forming) polymers useful as absorbents in absorbent members and articles such as disposable diapers need to have adequately high sorption capacity, as well as adequately high gel strength. Sorption capacity needs to be sufficiently high to enable the absorbent polymer to absorb significant amounts of the aqueous body fluids encountered during use of the absorbent article. Together with other properties of the gel, gel strength relates to the tendency of the swollen polymer particles to resist deformation under an applied stress. The gel strength needs to be high enough in the absorbent member or article, to reduce deformation and to avoid that the capillary void spaces between the particles are filled to an unacceptable degree, causing so-called gel blocking. This gel-blocking inhibits the rate of fluid uptake or the fluid distribution, i.e. once gel-blocking occurs, it can substantially impede the distribution of fluids to relatively dry zones or regions in the absorbent article and leakage from the absorbent article can take place well before the water-swellable polymer particles are fully saturated or before the fluid can diffuse or wick past the “blocking” particles into the rest of the absorbent article. Thus, it is important that the water-swellable polymers (when incorporated in an absorbent structure or article) have a high resistance against deformation thus maintaining a high wet-porosity, thus yielding high permeability for fluid transport through the swollen gel bed.

It is known in the art that absorbent polymers with relatively high permeability can be made by increasing the level of internal crosslinking and/or surface crosslinking, which increases the resistance of the swollen gel against deformation by an external pressure such as the pressure caused by the wearer, but this typically also reduces the absorbent capacity of the gel undesirably. To date, the manufacturer of water-swellable polymers will thus always have to select the surface crosslinking levels and internal cross-linking levels depending on the desired absorbent capacity and permeability.

It is a significant draw-back of this conventional approach that the absorbent capacity has to be sacrificed in order to gain permeability. The lower absorbent capacity must be compensated by higher dosage of the absorbent polymer in hygiene articles which for example leads to difficulties with the core integrity of a diaper or sanitary napkin during wear. Hence, special, technically challenging and expensive fixation technologies are required to overcome this issue and in addition higher costs are incurred by the required higher dosing level of the absorbent polymer itself.

The surface crosslinked water-swellable polymer particles are often constrained by their surface-crosslinked surface layer and cannot absorb or swell sufficiently; and also, the surface-crosslinked surface layer is not strong enough to withstand the stresses of swelling or the stresses associated with performance under load.

As a result thereof the surface-crosslinked surface layers of such water-swellable polymers, as used in the art, typically break when the polymer swells significantly. Often these surface-crosslinked water-swellable polymers deform significantly in use thus leading to relatively low porosity and permeability of the gel bed in the wet state.

Without wishing to be bound by any theory it is believed that the tangential forces that determine the stability against deformation are limited by the breaking of the shells or coatings.

The inventors have now found that the change in the absorbent capacity of the water-swellable material when it is submitted to a grinding method, is a measure to determine whether the original water-swellable material is such that it exerts a pressure, which is high enough to ensure a much improved permeability of the water-swellable material (when swollen), providing ultimately an improved absorbent capacity/permeability balance in use and an ultimately improved performance in use.

The inventors have also found a way to provide an improved water-swellable material which exhibits greatly improved resistance against deformation when swollen and which provides an improved stability against external pressure, even when swollen. The material typically comprises particles of water-swellable polymers with a specific shell, which creates an internal pressure, which is exerted onto the water-swellable polymers within this shell. Without wishing to be bound by any theory, it is believed that if this internal pressure is significantly higher than the external pressure, e.g. the pressure exerted by the wearer of an absorbent article that comprises water swellable material, the shell will provide the stability of the particles against deformation, as it will try to minimize the energy by assuming a round shape as much as possible. It is believed that the internal pressure in the water-swellable material should be at least 50% higher than the typical external pressure exerted onto the water-swellable material, based on the average external pressure in use in absorbent articles. The inventors found thus that the internal pressure created by the shell should therefore preferably be in the range of about 0.45 psi to about 1.05 psi, especially for water swellable materials that are used in absorbent articles such as baby diapers.

Just as the known surface-crosslinked water-swellable polymers described and available in the industry, comprising a surface-crosslinked outer surface, the shell of the water-swellable polymer particles of the water-swellable material of the invention will typically reduce the absorbent capacity of the water-swellable material to some degree, however, an improved balance is obtained with the water-swellable materials of the invention, due to the high pressure resistance of the shell whilst having a high expandability, allowing high absorbent capacity. Thus, the water-swellable material of the invention has an improved balance between absorbent capacity and permeability, compared to known surface cross-linked or coated water-swellable materials.

### SUMMARY OF THE INVENTION

In a first embodiment, the invention provides a water-swellable material, comprising particles that each have a core and a shell, and that comprise water-swellable polymers, typically comprised in said core, said shell preferably comprising an elastomeric polymer(s), said water-swellable material having an absorbent capacity of at least about 20 g/g (as measured in the 4-hour CCRC test), and having a Saline Absorbent Capacity (SAC), a Saline Absorbent Capacity after grinding (SAC″) and a QUICS value calculated therefrom, as defined herein, whereby said QUICS is at least 15, or more preferably at least 20 or even more preferably at least 30%, or even more preferably at least 50, or even more preferably at least 60 or even more preferably at least 70, and preferably up to 200, or more preferably up to 100.

In another embodiment, the invention provides a water-swellable material, comprising water-swellable polymers, said water-swellable material having an absorbent capacity of at least about 20 g/g (as measured in the 4-hour CCRC test), and having a Saline Absorbent Capacity (SAC), a Saline Absorbent Capacity after grinding (SAC″) and a QUICS value calculated therefrom, as defined herein, whereby said QUICS value is more than (5/3)+SAC″×(5/12).

Hereby, the QUICS values above may also be preferred.

In another embodiment, the invention provides a water-swellable material, comprising water-swellable polymers, said water-swellable material having an absorbent capacity of at least about 20 g/g (as measured in the 4-hour CCRC test), and having a Saline Absorbent Capacity (SAC), a Saline Absorbent Capacity after grinding (SAC″) and a QUICS value calculated therefrom, as defined herein, but whereby the QUICS is at least 15 and the material having a CS-SFC of at least 10 (expressed herein as 10⁻⁷ cm³sec/g), as defined herein.

The inventors also have found highly preferred elastomeric polymers which may be advantageously used in the water-swellable material herein, to provide the excellent permeability/absorbent capacity balance and the excellent QUICS values (QUICS of more than 10), namely said water-swellable material comprising one or more polyetherpolyurethane elastomeric polymer(s), that have main chain(s) and/or side chains with alkylene oxide units, preferably side chains with ethylene oxide units and/or main chains with butylene oxide units.

Preferred is so-called core shell water-swellable material, comprising particles with a core of water-swellable polymers and a shell of elastomeric polymers.

The inventors also have found a highly preferred process for making the water-swellable material herein above, and to provide the excellent permeability/absorbent capacity balance and the excellent QUICS values, having a QUICS of more than 10, namely, said water-swellable material being obtainable by a process comprising the steps of:
a) spray-coating said water-swellable polymeric particles with an elastomeric polymer at temperatures in the range from 0° C. to 50° C. and
b) heat-treating the coated particles at a temperature above 50° C.

Water-Swellable Material

The water-swellable material of the invention is such that it swells in water by absorbing the water; it may thereby form a gel. It may also absorb other liquids and swell. Thus, when used herein, ‘water-swellable’ means that the material swells at least in water, but typically also in other liquids or solutions, preferably in water based liquids such as 0.9% saline and urine.

The water-swellable material is solid; this includes gels, and particles, such as flakes, fibers, agglomerates, large blocks, granules, spheres, and other forms known in the art as ‘solid’ or ‘particles’.

The water-swellable material of the invention comprises water-swellable particles containing water-swellable polymer (s) (particle), said water-swellable particles preferably being present at a level of at least 50% to 100% by weight (of the water-swellable material) or even from 80% to 100% by weight, and most preferably the material consists of said water-swellable particles. Said water-swellable particles of the water-swellable material preferably have a core-shell structure, as described herein, whereby the core preferably comprises said water-swellable polymer(s), which are typically also particulate.

The water-swellable material of the invention has an absorbent capacity of at least 20 g/g (as measured in the 4-hour CCRC test, described herein), preferably at least 25 g/g, or even more preferably at least 30 g/g/, or even more preferably at least 40 g/g. The water swellable material of the invention may have an absorbent capacity of less than 80 g/g and or even less than 60 g/g as measured in the 4-hour CCRC test, described herein.

The water-swellable material herein has a Saline Absorbent Capacity (SAC), a Saline Absorbent Capacity after grinding (SAC″) and a QUICS value calculated therefrom, as defined by the methods described hereinafter. The difference between SAC″ and SAC and thus the QUICS calculated therefrom is believed to be a measure for the internal pressure exerted onto the core of the particles (containing water-swellable polymer) of the water-swellable material.

The QUICS values are as defined above, for the various water-swellable materials herein.

Highly preferred are water-swellable materials with a QUICS of at least 15, or more preferably at least 20, or even more preferably at least 30, and preferably up to 200 or even more preferably up to 150 or even more preferably up to 100.

The water-swellable material of the invention has a very high permeability or porosity, as represented by the CS-SFC value, as measured by the method set out herein.

The CS-SFC of the water-swellable material of the invention is typically at least 10×10⁻⁷ cm³·s/g, but preferably at least 30×10⁻⁷ cm³·s/g or more preferably at least 50×10⁻⁷ cm³·s/g or even more preferably at least 100×10⁻⁷ cm³·s/g. It may even be preferred that the CS-SFC is at least 500×10⁻⁷ cm³·s/g or even more preferably at least 1000×10⁻⁷ cm³·s/g, and it has been found to be even possible to have a CS-SFC of 2000×10⁻⁷ cm³·s/g or more.

Typically, the water-swellable material is particulate, having preferably particle sizes and distributions which are about equal to the preferred particle sizes/distributions of the water-swellable polymer particles, as described herein below, even when these particles comprise a shell of for example elastomeric polymers, because this shell is typically very thin and does not significantly impact the particle size of the particles of the water-swellable material.

Surprisingly it has been found that, in contrast to water-swellable polymer particles known in the art, the particles of the water-swellable material herein are typically substantially spherical when swollen, for example when swollen by the method set out in the 4 hour CCRC test, described below. Namely, the particles are, even when swollen, able to withstand the average external pressure to such a degree that hardly any deformation of the particles takes place, ensuring the highly improved permeability.

The sphericity of the swollen particles can be determined (visualized) by for example the PartAn method (optical method to determine size and shape of particles) or preferably by microscopy.

Preferably, the water-swellable material herein comprises elastomeric polymers, preferably present in or as a shell on the particle cores present in said material. The water absorbent materials of the present invention have a surprisingly beneficial combination or balance of absorbent capacity, as measured in the 4 hour CCRC test and permeability, as measured in the CS-SFC test, set out herein.

In particular, the water-swellable materials of the invention have a particularly beneficial absorbency-distribution-index (ADI) of more than 1, preferably at least 2, more preferably at least 3, even more preferably at least 6 and most preferable of at least about 10, whereby the ADI is defined as:

ADI=(CS-SFC/(150*10⁻⁷ cm³sec/g))/10^{2.5-0.095×(CCRC/g/g)}

Typically, the water-swellable materials will have an ADI of not more than about 200 and preferably not more than 50.

Shells and Preferred Elastomeric Polymers Thereof

The water-swellable material of the invention comprises preferably water-swellable particles, with a core-shell structure. Preferred is that said core comprises water-swellable polymer(s). It may also be preferred that said shell (on said core) comprises elastomeric polymers.

For the purpose of the invention, it should be understood that the shell will be present on the surface of the core, referred to herein; this includes the embodiment that said shell may form the outer surface of the particles, and the embodiment that the shell does not form the outer surface of the particles.

In a preferred execution, the water-swellable material comprises, or consists of, water-swellable particles, which have a core formed by particulate water-swellable polymer(s), as described herein, and this core forms the centre of the particles of the water-swellable material herein, and the water-swellable particles comprise each a shell, which is present on substantially the whole outer surface area of said core.

In one preferred embodiment of the invention, the shell is an essentially continuous layer around the water-swellable polymer core, and said layer covers the entire surface of the polymer core, i.e. no regions of the core surface are exposed. Hereto, the shell is typically formed by the preferred processes described herein after.

The shell, preferably formed in the preferred process described herein, is preferably pathwise connected and more preferably, the shell is pathwise connected and encapsulating (completely circumscribing) the core, e.g. of water-swellable polymer(s) (see for example E. W. Weinstein et. al., Mathworld—A Wolfram Web Resource for ‘encapsulation’ and ‘pathwise connected’). The shell is preferably a pathwise connected complete surface on the surface of the core. This complete surface consists of first areas where the shell is present and which are pathwise connected, e.g. like a network, but it may comprise second areas, where no shell is present, being for example micro pores, whereby said second areas are a disjoint union. Preferably, each second area, e.g. micropore, has a surface area in the dry state of less than 0.1 mm², or even less than 0.01 mm² preferably less than 8000 μm², more preferably less than 2000 μm² and even more preferably less than 80 μm². However, it is most preferred that no second areas are present, and that the shell forms a complete encapsulation around the core, e.g. of water-swellable polymer (s).

As said above, the shell preferably comprises elastomeric polymers, as described hereinafter. The shell of elastomeric polymers is preferably formed on the surface of the core of water-swellable polymer(s) by the method described hereinafter, e.g. preferably a dispersion or solution of the elastomeric polymers is sprayed onto the core of water-swellable polymers by the preferred processes described herein. It has surprisingly been found that these preferred process conditions further improve the resistance of the shell against pressure, improving the permeability of the water-swellable material whilst ensuring a good absorbency.

The shells herein have in general a high shell tension, which is defined as the (Theoretical equivalent shell caliper)×(Average wet secant elastic modulus at 400% elongation), of 5 to 200 N/m, or preferably of 10 to 170N/m, or more preferably 20 to 130 N/m. In some embodiments it may be preferred to have a shell with a shell tension of 40N/m to 110N/m.

In one embodiment of the invention where the water-swellable polymers herein have been (surface) post-crosslinked (either prior to application of the shell described herein, or at the same time as applying said shell), it may even be more preferred that the shell tension is in the range from 15 N/m to 60N/m, or even more preferably from 20 N/m to 60N/m, or preferably from 40 to 60 N/m.

In yet another embodiment wherein the water swellable polymers are not surface-crosslinked, it may even be more preferred that said shell tension is in the range from more than 60 N/m to 110 N/m.

The shell is preferably at least moderately water-permeable (breathable) with a moisture vapor transmission rate (MVTR; as can be determined by the method set out below) of more than 200 g/m²/day, preferably breathable with a MVTR of 800 g/m²/day or more preferably 1200 to (inclusive) 1400 g/m²/day, even more preferably breathable with a MVTR of at least 1500 g/m²/day, up to 2100 g/m²/day (inclusive), and most preferably the shell (e.g. the elastomeric polymer) is highly breathable with a MVTR of 2100 g/m²/day or more.

The shell herein is typically thin; preferably the shell has an average caliper (thickness) of at least 0.1 μm, typically between 1 micron (μm) and 100 microns, preferably from 1 micron to 50 microns, more preferably from 1 micron to 20 microns or even from 2 to 20 microns or even from 2 to 10 microns, as can be determined by the method described herein.

The shell is preferably uniform in caliper and/or shape. Preferably, the average caliper is such that the ratio of the smallest to largest caliper is from 1:1 to 1:5, preferably from 1:1 to 1:3, or even 1:1 to 1:2, or even 1:1 to 1:1.5.

Preferably, the water-swellable material has a shell of elastomeric polymer(s), which are typically film-forming elastomeric polymers, and typically thermoplastic film-forming elastomeric polymers.

The elastomeric polymer may be a polymer with at least one glass transition temperature of below 60° C.; preferred may be that the elastomeric polymer is a block copolymer, whereby at least one segment or block of the copolymer has a Tg below room temperature (i.e. below 25° C.; this is said to be the soft segment or soft block) and at least one segment or block of the copolymer that has a Tg above room temperature (and this is said to be the hard segment or hard block), as described in more detail below. The Tg's, as referred to herein, may be measured by methods known by people skilled in the art, e.g. Differential Scanning Calorimetry (DSC) to measure the change in specific heat that a material undergoes upon heating. The DSC measures the energy required to maintain the temperature of a sample to be the same as the temperature of the inert reference material (eg. Indium). A Tg is determined from the midpoint of the endothermic change in the slope of the baseline. The Tg values are reported from the second heating cycle so that any residual solvent in the sample is removed. However, the measurement of Tg may in practice be very difficult in cases when several Tg's are close together or for other experimental reasons. Even in cases when the Tg's cannot be determined clearly by experiment the polymer may still be suitable in the scope of the present invention.

Preferably, the water-swellable material comprises particles with a shell that comprises one or more elastomeric polymers (with at least one Tg of less than 60° C.) and said material has a shell impact parameter, which is defined as the (Average wet secant elastic modulus at 400% elongation)*(Relative Weight of said elastomeric polymer compared to the total weight of the water-swellable material) of 0.03 MPa to 0.6 MPa, preferably 0.07 MPa to 0.45 MPa, more preferably of 0.1 to 0.35 MPa. The relative weight percentage of the elastomeric polymer above may be determined by for example the pulsed NMR method described herein.

In a preferred embodiment, the water-swellable material comprises elastomeric polymers, typically present in the shell of the particles thereof, which are typically present at a weight percentage of (by weight of the water-swellable material) of 0.1% to 25%, or more preferably 0.5 to 15% or even more preferably to 10%, or even more preferably up to 5%. The skilled person would know the suitable methods to determine this. For example, for water-swellable materials comprising elastomeric polymers with at least one glass transition temperature (Tg) of less than 60° C. or less, the NMR method described herein below may be used.

In order to impart desirable properties to the elastomeric polymer, additionally fillers such as particulates, oils, solvents, plasticizers, surfactants, dispersants may be optionally incorporated.

The elastomeric polymer may be hydrophobic or hydrophilic. For fast wetting it is however preferable that the polymer is also hydrophilic.

The elastomeric polymer is preferably applied as, and present as in the form of a shell on the water-swellable poplymer particles, and this is preferably done by coating processes described herein, by use of a solution or a dispersion thereof. Such solutions and dispersions can be prepared using water and/or any suitable organic solvent, for example acetone, isopropanol, tetrahydrofuran, methyl ethyl ketone, dimethyl sulfoxide, dimethylformamide, chloroform, ethanol, methanol and mixtures thereof.

Elastomeric polymers which are applicable from solution are for example Vector® 4211 (Dexco Polymers, Texas, USA), Vector 4111, Septon 2063 (Septon Company of America, a Kuraray Group Company), Septon 2007, Estane® 58245 (Noveon, Cleveland, USA), Estane 4988, Estane 4986, Estane® X-1007, Estane T5410, Irogran PS370-201 (Huntsman Polyurethanes), Irogran VP 654/5, Pellethane 2103-70A (Dow Chemical Company), Elastollan® LP 9109 (Elastogran).

In a preferred embodiment the polymer is applied in the form of a, preferably aqueous, dispersion and in a more preferred embodiment the polymer is applied as an aqueous dispersion of a polyurethane, such as the preferred polyurethanes described below.

The synthesis of polyurethanes and the preparation of polyurethane dispersions is well described for example in Ullmann's Encyclopedia of Industrial Chemistry, Sixth Edition, 2000 Electronic Release.

The polyurethane is preferably hydrophilic and in particular surface hydrophilic. The surface hydrophilicity may be determined by methods known to those skilled in the art.

In a preferred execution, the hydrophilic polyurethanes are materials that are wetted by the liquid that is to be absorbed (0.9% saline; urine). They may be characterized by a contact angle that is less than 90 degrees. Contact angles can for example be measured with the Video-based contact angle measurement device, Krüss G10-G1041, available from Kruess, Germany or by other methods known in the art.

In a preferred embodiment, the hydrophilic properties are achieved as a result of the polyurethane comprising hydrophilic polymer blocks, for example polyether groups having a fraction of groups derived from ethylene glycol (CH₂CH₂O) or from 1,4-butanediol (CH₂CH₂CH₂CH₂O) or from 1,3-propanediol (CH₂CH₂CH₂O), or mixtures thereof.

Polyetherpolyurethanes are therefore preferred elastomeric polymers. The hydrophilic blocks can be constructed in the manner of comb polymers where parts of the side chains or all side chains are hydrophilic polymeric blocks. But the hydrophilic blocks can also be constituents of the main chain (i.e., of the polymer's backbone). A preferred embodiment utilizes polyurethanes where at least the predominant fraction of the hydrophilic polymeric blocks is present in the form of side chains. The side chains can in turn be block copolymers such as poly(ethylene glycol)-co-poly(propylene glycol).

Highly preferred are polyetherpolyurethanes with side chains with alkylene oxide units, preferably ethylene oxide units. Also preferred are polyetherpolyurethanes whereby the main chain comprises alkylene oxide units, preferably butylene oxide units.

It is further possible to obtain hydrophilic properties for the polyurethanes through an elevated fraction of ionic groups, preferably carboxylate, sulfonate, phosphonate or ammonium groups. The ammonium groups may be protonated or alkylated tertiary or quarternary groups. Carboxylates, sulfonates, and phosphates may be present as alkali-metal or ammonium salts. Suitable ionic groups and their respective precursors are for example described in “Ullmanns Encyclopädie der technischen Chemie”, 4^{th} Edition, Volume 19, p. 311-313 and are furthermore described in DE-A 1 495 745 and WO 03/050156.

The hydrophilicity of the preferred polyurethanes facilitates the penetration and dissolution of water into the water-swellable polymeric particles which are enveloped by the elastomeric polymer (shell).

Especially preferred phase-separating polyurethanes herein comprise one or more phase-separating block copolymers, having a weight average molecular weight Mw of at least 5 kg/mol, preferably at least 10 kg/mol and higher.

In one embodiment such a block copolymer has at least a first polymerized homopolymer segment (block) and a second polymerized homopolymer segment (block), polymerized with one another, whereby preferably the first (soft) segment has a Tg₁ of less than 20° C., or even less than 0° C., and the second (hard) segment has a Tg₂ of preferably 60° C. or more or even 70° C. or more.

In another embodiment, such a block copolymer has at least a first polymerized heteropolymer segment (block) and a second polymerized heteropolymer segment (block), polymerized with one another, whereby preferably the first (soft) segment has a Tg₁ of less than 20° C., or even less than 0° C., and the second (hard) segment has a Tg₂ of preferably 60° C. or more or even 70° C. or more.

In one embodiment the total weight average molecular weight of the hard second segments (with a Tg of at least 50° C.) is preferably at least 28 kg/mol, or even at least 45 kg/mol.

The preferred weight average molecular weight of a first (soft) segment (with a Tg of less than 20° C.) is at least 500 g/mol, preferably at least 1000 g/mol or even at least 2000 g/mol, but preferably less than 8000 g/mol, preferably less than 5000 g/mol.

However, the total of the first (soft) segments is typically 20% to 95% by weight of the total block copolymer, or even from 20% to 85% or more preferably from 30% to 75% or even from 40% to 70% by weight. Furthermore, when the total weight level of soft segments is more than 70%, it is even more preferred that an individual soft segment has a weight average molecular weight of less than 5000 g/mol.

It is well understood by those skilled in the art that “polyurethanes” is a generic term used to describe polymers that are obtained by reacting di- or polyisocyanates with at least one di- or polyfunctional “active hydrogen-containing” compound. “Active hydrogen containing” means that the di- or polyfunctional compound has at least 2 functional groups which are reactive toward isocyanate groups (also referred to as reactive groups), e.g. hydroxyl groups, primary and secondary amino groups and mercapto (SH) groups.

It also is well understood by those skilled in the art that polyurethanes also include allophanate, biuret, carbodiimide, oxazolidinyl, isocyanurate, uretdione, and other linkages in addition to urethane and urea linkages.

In one embodiment the block copolymers useful herein are preferably polyether urethanes and polyester urethanes. Especially preferred are polyether urethanes comprising polyalkylene glycol units, especially polyethylene glycol units or poly(tetramethylene glycol) units.

As used herein, the term “alkylene glycol” includes both alkylene glycols and substituted alkylene glycols having 2 to 10 carbon atoms, such as ethylene glycol, 1,3-propylene glycol, 1,2-propylene glycol, 1,2-butylene glycol, 1,3-butylene glycol, 1,4-butylene glycol, styrene glycol and the like.

The polyurethanes used according to the present invention are generally obtained by reaction of polyisocyanates with active hydrogen-containing compounds having two or more reactive groups. These include
a) high molecular weight compounds having a molecular weight in the range of preferably 300 to 100 000 g/mol especially from 500 to 30 000 g/mol
b) low molecular weight compounds and
c) compounds having polyether groups, especially polyethylene oxide groups or polytetrahydrofuran groups and a molecular weight in the range from 200 to 20 000 g/mol, the polyether groups in turn having no reactive groups.

These compounds can also be used as mixtures.

Suitable polyisocyanates have an average of about two or more isocyanate groups, preferably an average of about two to about four isocyanate groups and include aliphatic, cycloaliphatic, araliphatic, and aromatic polyisocyanates, used alone or in mixtures of two or more. Diisocyanates are more preferred. Especially preferred are aliphatic and cycloaliphatic polyisocyanates, especially diisocyanates.

Specific examples of suitable aliphatic diisocyanates include alpha, omega-alkylene diisocyanates having from 5 to 20 carbon atoms, such as hexamethylene-1,6-diisocyanate, 1,12-dodecane diisocyanate, 2,2,4-trimethylhexamethylene diisocyanate, 2,4,4-trimethyl-hexamethylene diisocyanate, 2-methyl-1,5-pentamethylene diisocyanate, and the like. Polyisocyanates having fewer than 5 carbon atoms can be used but are less preferred because of their high volatility and toxicity. Preferred aliphatic polyisocyanates include hexamethylene-1,6-diisocyanate, 2,2,4-trimethyl-hexamethylene diisocyanate, and 2,4,4-trimethyl-hexamethylene diisocyanate.

Specific examples of suitable cycloaliphatic diisocyanates include dicyclohexylmethane diisocyanate, (commercially available as Desmodur® W from Bayer Corporation), isophorone diisocyanate, 1,4-cyclohexane diisocyanate, 1,3-bis(isocyanatomethyl)cyclohexane, and the like. Preferred cycloaliphatic diisocyanates include dicyclohexylmethane diisocyanate and isophorone diisocyanate.

Specific examples of suitable araliphatic diisocyanates include m-tetramethyl xylylene diisocyanate, p-tetramethyl xylylene diisocyanate, 1,4-xylylene diisocyanate, 1,3-xylylene diisocyanate, and the like. A preferred araliphatic diisocyanate is tetramethyl xylylene diisocyanate.

Examples of suitable aromatic diisocyanates include 4,4′-diphenylmethane diisocyanate, toluene diisocyanate, their isomers, naphthalene diisocyanate, and the like. A preferred aromatic diisocyanate is toluene diisocyanate and 4,4′-diphenylmethane diisocyanate.

Examples of high molecular weight compounds a) having 2 or more reactive groups are such as polyester polyols and polyether polyols, as well as polyhydroxy polyester amides, hydroxyl-containing polycaprolactones, hydroxyl-containing acrylic copolymers, hydroxyl-containing epoxides, polyhydroxy polycarbonates, polyhydroxy polyacetals, polyhydroxy polythioethers, polysiloxane polyols, ethoxylated polysiloxane polyols, polybutadiene polyols and hydrogenated polybutadiene polyols, polyacrylate polyols, halogenated polyesters and polyethers, and the like, and mixtures thereof. The polyester polyols, polyether polyols, polycarbonate polyols, polysiloxane polyols, and ethoxylated polysiloxane polyols are preferred. Particular preference is given to polyesterpolyols, polycarbonate polyols and polyalkylene ether polyols. The number of functional groups in the aforementioned high molecular weight compounds is preferably on average in the range from 1.8 to 3 and especially in the range from 2 to 2.2 functional groups per molecule.

The polyester polyols typically are esterification products prepared by the reaction of organic polycarboxylic acids or their anhydrides with a stoichiometric excess of a diol. The diols used in making the polyester polyols include alkylene glycols, e.g., ethylene glycol, 1,2- and 1,3-propylene glycols, 1,2-, 1,3-, 1,4-, and 2,3-butane diols, hexane diols, neopentyl glycol, 1,6-hexanediol, 1,8-octanediol, and other glycols such as bisphenol-A, cyclohexanediol, cyclohexane dimethanol (1,4-bis-hydroxymethylcyclohexane), 2-methyl-1,3-propanediol, 2,2,4-trimethyl-1,3-pentanediol, diethylene glycol, triethylene glycol, tetraethylene glycol, polyethylene glycol, dipropylene glycol, polypropylene glycol, dibutylene glycol, polybutylene glycol, dimerate diol, hydroxylated bisphenols, polyether glycols, halogenated diols, and the like, and mixtures thereof. Preferred diols include ethylene glycol, diethylene glycol, butane diol, hexane diol, and neopentylglycol. Alternatively or in addition, the equivalent mercapto compounds may also be used.

Suitable carboxylic acids used in making the polyester polyols include dicarboxylic acids and tricarboxylic acids and anhydrides, e.g., maleic acid, maleic anhydride, succinic acid, glutaric acid, glutaric anhydride, adipic acid, suberic acid, pimelic acid, azelaic acid, sebacic acid, chlorendic acid, 1,2,4-butane-tricarboxylic acid, phthalic acid, the isomers of phthalic acid, phthalic anhydride, fumaric acid, dimeric fatty acids such as oleic acid, and the like, and mixtures thereof. Preferred polycarboxylic acids used in making the polyester polyols include aliphatic or aromatic dibasic acids.

Examples of suitable polyester polyols include poly(glycol adipate)s, poly(ethylene terephthalate) polyols, polycaprolactone polyols, orthophthalic polyols, sulfonated and phosphonated polyols, and the like, and mixtures thereof.

The preferred polyester polyol is a diol. Preferred polyester diols include poly(butanediol adipate); hexanediol adipic acid and isophthalic acid polyesters such as hexaneadipate isophthalate polyester; hexanediol neopentyl glycol adipic acid polyester diols, e.g., Piothane 67-3000 HNA (Panolam Industries) and Piothane 67-1000 HNA, as well as propylene glycol maleic anhydride adipic acid polyester diols, e.g., Piothane SO-1000 PMA, and hexane diol neopentyl glycol fumaric acid polyester diols, e.g., Piothane 67-SO0 HNF. Other preferred Polyester diols include Rucoflex®S101.5-3.5, S1040-3.5, and S-1040-110 (Bayer Corporation).

Polyether polyols are obtained in known manner by the reaction of a starting compound that contains reactive hydrogen atoms, such as water or the diols set forth for preparing the polyester polyols, and alkylene glycols or cyclic ethers, such as ethylene glycol, propylene glycol, butylene glycol, styrene glycol, ethylene oxide, propylene oxide, 1,2-butylene oxide, 2,3-butylene oxide, oxetane, tetrahydrofuran, epichlorohydrin, and the like, and mixtures thereof. Preferred polyethers include poly(ethylene glycol), poly(propylene glycol), polytetrahydrofuran, and co [poly(ethylene glycol)poly(propylene glycol)]. Polyethylenglycol and Polypropyleneglycol can be used as such or as physical blends. In case that propyleneoxide and ethylenoxide are copolymerized, these polypropyleneoxide-co-polyethyleneoxide polymers can be used as random polymers or block-copolymers.

In one embodiment the polyetherpolyol is a constituent of the main polymer chain. In another embodiment the polyetherol is a terminal group of the main polymer chain. In yet another embodiment the polyetherpolyol is a constituent of a side chain which is comb-like attached to the main chain. An example of such a monomer is Tegomer D-3403 (Degussa).

Polycarbonates include those obtained from the reaction of diols such as 1,3-propanediol, 1,4-butanediol, 1,6-hexanediol, diethylene glycol, triethylene glycol, tetraethylene glycol, and the like, and mixtures thereof with dialkyl carbonates such as diethyl carbonate, diaryl carbonates such as diphenyl carbonate or phosgene.

Examples of low molecular weight compounds b) having two reactive functional groups are the diols such as alkylene glycols and other diols mentioned above in connection with the preparation of polyesterpolyols. They also include amines such as diamines and polyamines which are among the preferred compounds useful in preparing the aforesaid polyesteramides and polyamides. Suitable diamines and polyamines include 1,2-diaminoethane, 1,6-diaminohexane, 2-methyl-1,5-pentanediamine, 2,2,4-trimethyl-1,6-hexanediamine, 1,12-diaminododecane, 2-aminoethanol, 2-[(2-aminoethyl)amino]-ethanol, piperazine, 2,5-dimethylpiperazine, 1-amino-3-aminomethyl-3,5,5-trimethylcyclohexane (isophorone diamine or IPDA), bis-(4-aminocyclohexyl)-methane, bis-(4-amino-3-methyl-cyclohexyl)-methane, 1,4-diaminocyclohexane, 1,2-propylenediamine, hydrazine, urea, amino acid hydrazides, hydrazides of semicarbazidocarboxylic acids, bis-hydrazides and bis-semicarbazides, diethylene triamine, triethyllene tetramine, tetraethylene pentamine, pentaethylene hexamine, N,N,N-tris-(2-aminoethyl)amine, N-(2-piperazinoethyl)-ethylene diamine, N,N′-bis-(2-aminoethyl)piperazine, N,N,N′-tris-(2-aminoethyl)ethylene diamine, N—[N-(2-aminoethyl)-2-aminoethyl]-N′-(2-aminoethyl)-piperazine, N-(2-aminoethyl)-N′-(2-piperazinoethyl)ethylene diamine, N,N-bis-(2-aminoethyl)-N-(2-piperazinoethyl)amine, N,N-bis-(2-piperazinoethyl)amine, polyethylene imines, iminobispropylamine, guanidine, melamine, N-(2-aminoethyl)-1,3-propane diamine, 3,3′-diaminobenzidine, 2,4,6-triaminopyrim idine, polyoxypropylene amines, tetrapropylenepentamine, tripropylenetetramine, N,N-bis-(6-aminohexyl)amine, N,N′-bis-(3-aminopropyl)ethylene diamine, and 2,4-bis-(4′-aminobenzyl)-aniline, and the like, and mixtures thereof. Preferred diamines and polyamines include 1-amino-3-aminomethyl-3,5,5-trimethyl-cyclohexane (isophorone diamine or IPDA), bis-(4-aminocyclohexyl)-methane, bis-(4-amino-3-methylcyclohexyl)-methane, ethylene diamine, diethylene triamine, triethylene tetramine, tetraethylene pentamine, and pentaethylene hexamine, and the like, and mixtures thereof. Other suitable diamines and polyamines for example include Jeffamine® D-2000 and D-4000, which are amine-terminated polypropylene glycols differing only by molecular weight, and Jeffamine® XTJ-502, T 403, T 5000, and T 3000 which are amine terminated polyethyleneglycols, amine terminated co-polypropylenepolyethylene glycols, and triamines based on propoxylated glycerol or trimethylolpropane and which are available from Huntsman Chemical Company.

The poly(alkylene glycol) may be part of the polymer main chain or be attached to the main chain in comb-like shape as a side chain.

In a preferred embodiment, the polyurethane comprises poly(alkylene glycol) side chains sufficient in amount to comprise about 10 wt. % to 90 wt. %, preferably about 12 wt. % to about 80 wt. %, preferably about 15 wt. % to about 60 wt. %, and more preferably about 20 wt. % to about 50 wt. %, of poly(alkylene glycol) units in the final polyurethane on a dry weight basis. At least about 50 wt. %, preferably at least about 70 wt. %, and more preferably at least about 90 wt. % of the poly(alkylene glycol) side-chain units comprise poly(ethylene glycol), and the remainder of the side-chain poly(alkylene glycol) units can comprise alkylene glycol and substituted alkylene glycol units having from 3 to about 10 carbon atoms. The term “final polyurethane” means the polyurethane used for the shell of the water-swellable-polymeric particles.

Preferably the amount of the side-chain units is (i) at least about 30 wt. % when the molecular weight of the side-chain units is less than about 600 g/mol, (ii) at least about 15 wt. % when the molecular weight of the side-chain units is from about 600 to about 1000 g/mol, and (iii) at least about 12 wt. % when the molecular weight of said side-chain units is more than about 1000 g/mol. Mixtures of active hydrogen-containing compounds having such poly(alkylene glycol) side chains can be used with active hydrogen-containing compounds not having such side chains.

These side chains can be incorporated in the polyurethane by replacing a part or all of the aforementioned high molecular weight diols a) or low molecular weight compounds b) by compounds c) having at least two reactive functional groups and a polyether group, preferably a polyalkylene ether group, more preferably a polyethylene glycol group that has no reactive group.

For example, active hydrogen-containing compounds having a polyether group, in particular a poly(alkylene glycol) group, include diols having poly(ethylene glycol) groups such as those described in U.S. Pat. No. 3,905,929 (incorporated herein by reference in its entirety). Further, U.S. Pat. No. 5,700,867 (incorporated herein by reference in its entirety) teaches methods for incorporation of poly(ethylene glycol) side chains at col. 4, line 3.5 to col. 5, line 4.5. A preferred active hydrogen-containing compound having poly(ethylene glycol) side chains is trimethylol propane mono (polyethylene oxide methyl ether), available as Tegomer D-3403 from Degussa-Goldschmidt.

Preferably, the polyurethanes to be used in the present invention also have reacted therein at least one active hydrogen-containing compound not having said side chains and typically ranging widely in molecular weight from about 50 to about 10,000 g/mol, preferably about 200 to about 6000 g/mol, and more preferably about 300 to about 3000 g/mol. Suitable active hydrogen-containing compounds not having said side chains include any of the amines and polyols described herein as compounds a) and b).

According to one preferred embodiment of the invention, the active hydrogen compounds are chosen to provide less than about 25 wt. %, more preferably less than about 15 wt. % and most preferably less than about 5 wt. % poly(ethylene glycol) units in the backbone (main chain) based upon the dry weight of final polyurethane, since such main-chain poly(ethylene glycol) units tend to cause swelling of polyurethane particles in the waterborne polyurethane dispersion and also contribute to lower in use tensile strength of articles made from the polyurethane dispersion.

The preparation of polyurethanes having polyether side chains is known to one skilled in the art and is extensively described for example in US 2003/0195293, which is hereby expressly incorporated herein by reference.

The present invention accordingly also provides a water-swellable material comprising water-swellable polymeric particles with an elastomeric polyurethane shell, wherein the polyurethane comprises not only side chains having polyethylene oxide units but also polyethylene oxide units in the main chain.

Advantageous polyurethanes within the realm of this invention are obtained by first preparing prepolymers having isocyanate end groups, which are subsequently linked together in a chain-extending step. The linking together can be through water or through reaction with a compound having at least one crosslinkable functional group.

The prepolymer is obtained by reacting one of the above-described isocyanate compounds with an active hydrogen compound. Preferably the prepolymer is prepared from the above mentioned polyisocyanates, at least one compound c) and optionally at least one further active hydrogen compound selected from the compounds a) and b).

In one embodiment the ratio of isocyanate to active hydrogen in the compounds forming the prepolymer typically ranges from about 1.3/1 to about 2.5/1, preferably from about 1.5/1 to about 2.1/1, and more preferably from about 1.7/1 to about 2/1.

The polyurethane may additionally contain functional groups which can undergo further crosslinking reactions and which can optionally render them self-crosslinkable.

Compounds having at least one additional crosslinkable functional group include those having carboxylic, carbonyl, amine, hydroxyl, and hydrazide groups, and the like, and mixtures of such groups. The typical amount of such optional compound is up to about 1 milliequivalent, preferably from about 0.05 to about 0.5 milliequivalent, and more preferably from about 0.1 to about 0.3 milliequivalent per gram of final polyurethane on a dry weight basis.

The preferred monomers for incorporation into the isocyanate-terminated prepolymer are hydroxy-carboxylic acids having the general formula (HO)ₓQ(COOH)_{y} wherein Q is a straight or branched hydrocarbon radical having 1 to 12 carbon atoms, and x and y are 1 to 3. Examples of such hydroxy-carboxylic acids include citric acid, dimethylolpropanoic acid (DMPA), dimethylol butanoic acid (DMBA), glycolic acid, lactic acid, malic acid, dihydroxymalic acid, tartaric acid, hydroxypivalic acid, and the like, and mixtures thereof. Dihydroxy-carboxylic acids are more preferred with dimethylolpropanoic acid (DMPA) being most preferred.

Other suitable compounds providing crosslinkability include thioglycolic acid, 2,6-dihydroxybenzoic acid, and the like, and mixtures thereof.

Optional neutralization of the prepolymer having pendant carboxyl groups converts the carboxyl groups to carboxylate anions, thus having a water-dispersibility enhancing effect. Suitable neutralizing agents include tertiary amines, metal hydroxides, ammonia, and other agents well known to those skilled in the art.

As a chain extender, at least one of water, an inorganic or organic polyamine having an average of about 2 or more primary and/or secondary amine groups, polyalcohols, ureas, or combinations thereof is suitable for use in the present invention. Suitable organic amines for use as a chain extender include diethylene triamine (DETA), ethylene diamine (EDA), meta-xylylenediamine (MXDA), aminoethyl ethanolamine (AEEA), 2-methyl pentane diamine, and the like, and mixtures thereof. Also suitable for practice in the present invention are propylene diamine, butylene diamine, hexamethylene diamine, cyclohexylene diamine, phenylene diamine, tolylene diamine, 3,3-dichlorobenzidene, 4,4′-methylene-bis-(2-chloroaniline), 3,3-dichloro-4,4-diamino diphenylmethane, sulfonated primary and/or secondary amines, and the like, and mixtures thereof. Suitable inorganic and organic amines include hydrazine, substituted hydrazines, and hydrazine reaction products, and the like, and mixtures thereof. Suitable polyalcohols include those having from 2 to 12 carbon atoms, preferably from 2 to 8 carbon atoms, such as ethylene glycol, diethylene glycol, neopentyl glycol, butanediols, hexanediol, and the like, and mixtures thereof. Suitable ureas include urea and its derivatives, and the like, and mixtures thereof. Hydrazine is preferred and is most preferably used as a solution in water. The amount of chain extender typically ranges from about 0.5 to about 0.95 equivalents based on available isocyanate.

A degree of branching of the polyurethane may be beneficial, but is not required to maintain a high tensile strength and improve resistance to creep (cf. strain relaxation). This degree of branching may be accomplished during the prepolymer step or the extension step. For branching during the extension step, the chain extender DETA is preferred, but other amines having an average of about two or more primary and/or secondary amine groups may also be used. For branching during the prepolymer step, it is preferred that trimethylol propane (TMP) and other polyols having an average of more than two hydroxyl groups be used. The branching monomers can be present in amounts up to about 4 wt. % of the polymer backbone.

Polyurethanes are preferred elastomeric polymers. They can be applied to the water-swellable polymer particles from solvent or from a dispersion. Particularly preferred are aqueous dispersions.

Preferred aqueous polyurethane dispersions are Hauthane HD-4638 (ex Hauthaway), Hydrolar HC 269 (ex Colm, Italy), Impraperm 48180 (ex Bayer Material Science AG, Germany), Lupraprot DPS (ex BASF Germany), Permax 120, Permax 200, and Permax 220 (ex Noveon, Brecksville, Ohio), ), Syntegra YM2000 and Syntegra YM2100 (ex Dow, Midland, Mich.) Witcobond G-213, Witcobond G-506, Witcobond G-507, and Witcobond 736 (ex Uniroyal Chemical, Middlebury, Conn.).

Particularly suitable elastomeric polyurethanes are extensively described in the literature references hereinbelow and expressly form part of the subject matter of the present disclosure. Particularly hydrophilic thermoplastic polyurethanes are sold by Noveon, Brecksville, Ohio, under the tradenames of Permax® 120, Permax 200 and Permax 220 and are described in detail in “Proceedings International Waterborne High Solids Coatings, 32, 299, 2004” and were presented to the public in February 2004 at the “International Waterborne, High-Solids, and Powder Coatings Symposium” in New Orleans, USA. The preparation is described in detail in US 2003/0195293. Furthermore, the polyurethanes described in U.S. Pat. No. 4,190,566, U.S. Pat. No. 4,092,286, US 2004/0214937 and also WO 03/050156 expressly form part of the subject matter of the present disclosure.

More particularly, the polyurethanes described can be used in mixtures with each other or with other elastomeric polymers, fillers, oils, water-soluble polymers or plasticizing agents in order that particularly advantageous properties may be achieved with regard to hydrophilicity, water perviousness and mechanical properties.

It may be preferred that the elastomeric polymers herein comprises fillers to reduce tack such as the commercially available resin Estane 58245-047P and Estane X-1007-040P, available from Noveon Inc., 9911 Brecksville Road, Cleveland, Ohio 44 141-3247, USA.

Alternatively such fillers can be added in order to reduce tack to the dispersions or solutions of suitable elastomeric polymers before application. A typical filler is Aerosil, but other inorganic deagglomeration aids as listed below can also be used.

Preferred polyurethanes for use herein are strain hardening and/or strain crystallizing. Strain Hardening is observed during stress-strain measurements, and is evidenced as the rapid increase in stress with increasing strain. It is generally believed that strain hardening is caused by orientation of the polymer chains in the film producing greater resistance to extension in the direction of drawing.

Water-Swellable Polymers

The water-swellable polymers herein are preferably solid, preferably in the form of particles (which includes for example particles in the form of flakes, fibres, agglomerates). The water-swellable polymer particles can be spherical in shape as well as irregularly shaped particles.

Useful for the purposes of the present invention are in principle all particulate water-swellable polymers known to one skilled in the art from superabsorbent literature for example as described in Modern Superabsorbent Polymer Technology, F. L. Buchholz, A. T. Graham, Wiley 1998. The water-swellable particles are preferably spherical water-swellable particles of the kind typically obtained from inverse phase suspension polymerizations; they can also be optionally agglomerated at least to some extent to form larger irregular particles. But most particular preference is given to commercially available irregularly shaped particles of the kind obtainable by current state of the art production processes as is more particularly described herein below by way of example.

The water-swellable polymers are preferably polymeric particles obtainable by polymerization of a monomer solution comprising
i) at least one ethylenically unsaturated acid-functional monomer,
ii) at least one crosslinker,
iii) if appropriate one or more ethylenically and/or allylically unsaturated monomers copolymerizable with i) and
iv) if appropriate one or more water-soluble polymers onto which the monomers i), ii) and if appropriate iii) can be at least partially grafted,
   wherein the base polymer obtained thereby is dried, classified and if appropriate is subsequently treated with
v) at least one post-crosslinker (or: surface cross-linker)
   before being dried and optionally thermally post-crosslinked (ie. Surface crosslinked).

Useful monomers i) include for example ethylenically unsaturated carboxylic acids, such as acrylic acid, methacrylic acid, maleic acid, fumaric acid, and itaconic acid, or derivatives thereof, such as acrylamide, methacrylamide, acrylic esters and methacrylic esters. Acrylic acid and methacrylic acid are particularly preferred monomers. Acrylic acid is most preferable.

The water-swellable polymers to be used according to the present invention are typically crosslinked, i.e., the polymerization is carried out in the presence of compounds having two or more polymerizable groups which can be free-radically copolymerized into the polymer network. Useful crosslinkers ii) include for example ethylene glycol dimethacrylate, diethylene glycol diacrylate, allyl methacrylate, trimethylolpropane triacrylate, triallylamine, tetraallyloxyethane as described in EP-A 530 438, di- and triacrylates as described in EP-A 547 847, EP-A 559 476, EP-A 632 068, WO 93/21237, WO 03/104299, WO 03/104300, WO 03/104301 and in the German patent application 103 31 450.4, mixed acrylates which, as well as acrylate groups, comprise further ethylenically unsaturated groups, as described in German patent applications 103 31 456.3 and 103 55 401.7, or crosslinker mixtures as described for example in DE-A 195 43 368, DE-A 196 46 484, WO 90/15830 and WO 02/32962.

Useful crosslinkers ii) include in particular N,N′-methylenebisacrylamide and N,N′-methylenebismethacrylamide, esters of unsaturated mono- or polycarboxylic acids of polyols, such as diacrylate or triacrylate, for example butanediol diacrylate, butanediol dimethacrylate, ethylene glycol diacrylate, ethylene glycol dimethacrylate and also trimethylolpropane triacrylate and allyl compounds, such as allyl (meth)acrylate, triallyl cyanurate, diallyl maleate, polyallyl esters, tetraallyloxyethane, triallylamine, tetraallylethylenediamine, allyl esters of phosphoric acid and also vinylphosphonic acid derivatives as described for example in EP-A 343 427. Useful crosslinkers ii) further include pentaerythritol diallyl ether, pentaerythritol triallyl ether, pentaerythritol tetraallyl ether, polyethylene glycol diallyl ether, ethylene glycol diallyl ether, glycerol diallyl ether, glycerol triallyl ether, polyallyl ethers based on sorbitol, and also ethoxylated variants thereof. The process of the present invention preferably utilizes di(meth)acrylates of polyethylene glycols, the polyethylene glycol used having a molecular weight between 300 g/mole and 1000 g/mole.

However, particularly advantageous crosslinkers ii) are di- and triacrylates of altogether 3- to 15-tuply ethoxylated glycerol, of altogether 3- to 15-tuply ethoxylated trimethylolpropane, especially di- and triacrylates of altogether 3-tuply ethoxylated glycerol or of altogether 3-tuply ethoxylated trimethylolpropane, of 3-tuply propoxylated glycerol, of 3-tuply propoxylated trimethylolpropane, and also of altogether 3-tuply mixedly ethoxylated or propoxylated glycerol, of altogether 3-tuply mixedly ethoxylated or propoxylated trimethylolpropane, of altogether 15-tuply ethoxylated glycerol, of altogether 15-tuply ethoxylated trimethylolpropane, of altogether 40-tuply ethoxylated glycerol and also of altogether 40-tuply ethoxylated trimethylolpropane, here n-tuply ethoxylated means that n mols of ethylene oxide are reacted to one mole of the respective polyol with n being an integer number larger than 0.

Very particularly preferred for use as crosslinkers ii) are diacrylated, dimethacrylated, triacrylated or trimethacrylated multiply ethoxylated and/or propoxylated glycerols as described for example in prior German patent application DE 103 19 462.2. Di- and/or triacrylates of 3- to 10-tuply ethoxylated glycerol are particularly advantageous. Very particular preference is given to di- or triacrylates of 1- to 5-tuply ethoxylated and/or propoxylated glycerol. The triacrylates of 3- to 5-tuply ethoxylated and/or propoxylated glycerol are most preferred. These are notable for particularly low residual levels in the water-swellable polymer (typically below 10 ppm) and the aqueous extracts of water-swellable polymers produced therewith have an almost unchanged surface tension compared with water at the same temperature (typically not less than 0.068 N/m).

Examples of ethylenically unsaturated monomers iii) which are copolymerizable with the monomers i) are acrylamide, methacrylamide, crotonamide, dimethylaminoethyl methacrylate, dimethylaminoethyl acrylate, dimethylaminopropyl acrylate, diethylaminopropyl acrylate, dimethylaminobutyl acrylate, dimethylaminoethyl methacrylate, diethylaminoethyl methacrylate, dimethylaminoneopentyl acrylate and dimethylaminoneopentyl methacrylate.

Useful water-soluble polymers iv) include polyvinyl alcohol, polyvinylpyrrolidone, starch, starch derivatives, polyglycols, polyacrylic acids, polyvinylamine or polyallylamine, partially hydrolysed polyvinylformamide or polyvinylacetamide, preferably polyvinyl alcohol and starch.

Preference is given to water-swellable polymeric particles whose base polymer is lightly crosslinked.

Particular preference is given to base polymers having a 16 h extractables fraction of not more than 20% by weight, preferably not more than 15% by weight, even more preferably not more than 10% by weight and most preferably not more than 7% by weight.

The preparation of a suitable base polymer and also further useful hydrophilic ethylenically unsaturated monomers i) are described in DE-A 199 41 423, EP-A 686 650, WO 01/45758 and WO 03/14300.

The reaction is preferably carried out in a kneader as described for example in WO 01/38402, or on a belt reactor as described for example in EP-A-955 086.

It is further possible to use any conventional inverse suspension polymerization process. If appropriate, the fraction of crosslinker can be greatly reduced or completely omitted in such an inverse suspension polymerization process, since self-crosslinking occurs in such processes under certain conditions known to one skilled in the art.

It is further possible to make base polymers using any desired spray polymerization process.

The acid groups of the base polymers obtained are preferably 30-100 mol %, more preferably 65-90 mol % and most preferably 72-85 mol % neutralized, for which the customary neutralizing agents can be used, for example ammonia, or amines, such as ethanolamine, diethanolamine, triethanolamine or dimethylaminoethanolamine, preferably alkali metal hydroxides, alkali metal oxides, alkali metal carbonates or alkali metal bicarbonates and also mixtures thereof, in which case sodium and potassium are particularly preferred as alkali metals, but most preferred is sodium hydroxide, sodium carbonate or sodium bicarbonate and also mixtures thereof. Typically, neutralization is achieved by admixing the neutralizing agent as an aqueous solution or as an aqueous dispersion or else preferably as a molten or as a solid material.

Neutralization can be carried out after polymerization, at the base polymer stage. But it is also possible to neutralize up to 40 mol %, preferably from 10 to 30 mol % and more preferably from 15 to 25 mol % of the acid groups before polymerization by adding a portion of the neutralizing agent to the monomer solution and to set the desired final degree of neutralization only after polymerization, at the base polymer stage. The monomer solution may be neutralized by admixing the neutralizing agent, either to a predetermined degree of preneutralization with subsequent post-neutralization to the final value after or during the polymerization reaction, or the monomer solution is directly adjusted to the final value by admixing the neutralizing agent before polymerization. The base polymer can be mechanically comminuted, for example by means of a meat grinder, in which case the neutralizing agent can be sprayed, sprinkled or poured on and then carefully mixed in. To this end, the gel mass obtained can be repeatedly minced for homogenization.

The neutralized base polymer is then dried with a belt, fluidized bed, tower dryer or drum dryer until the residual moisture content is preferably below 13% by weight, especially below 8% by weight and most preferably below 4% by weight, the water content being determined according to EDANA's recommended test method No. 430.2-02 “Moisture content” (EDANA=European Disposables and Nonwovens Association). The dried base polymer is thereafter ground and sieved, useful grinding apparatus typically include roll mills, pin mills, hammer mills, jet mills or swing mills.

The water-swellable polymers to be used can be post-crosslinked (surface crosslinked) in one version of the present invention.

Useful post-crosslinkers v) include compounds comprising two or more groups capable of forming covalent bonds with the carboxylate groups of the polymers. Useful compounds include for example alkoxysilyl compounds, polyaziridines, polyamines, polyamidoamines, di- or polyglycidyl compounds as described in EP-A 083 022, EP-A 543 303 and EP-A 937 736, polyhydric alcohols as described in DE-C 33 14 019. Useful post-crosslinkers v) are further said to include by DE-A 40 20 780 cyclic carbonates, by DE-A 198 07 502 2-oxazolidone and its derivatives, such as N-(2-hydroxyethyl)-2-oxazolidone, by DE-A 198 07 992 bis- and poly-2-oxazolidones, by DE-A 198 54 573 2-oxotetrahydro-1,3-oxazine and its derivatives, by DE-A 198 54 574 N-acyl-2-oxazolidones, by DE-A 102 04 937 cyclic ureas, by German patent application 103 34 584.1 bicyclic amide acetals, by EP-A 1 199 327 oxetanes and cyclic ureas and by WO 03/031482 morpholine-2,3-dione and its derivatives.

Post-crosslinking is typically carried out by spraying a solution of the post-crosslinker onto the base polymer or the dry base-polymeric particles. Spraying is followed by thermal drying, and the post-crosslinking reaction can take place not only before but also during drying.

Preferred post-crosslinkers v) are amide acetals or carbamic esters of the general formula I

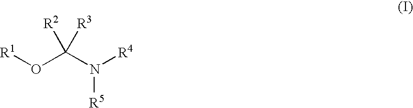

where
R¹ is C₁-C₁₂-alkyl, C₂-C₁₂-hydroxyalkyl, C₂-C₁₂-alkenyl or C₆-C₁₂-aryl,
R² is X or OR⁶
R³ is hydrogen, C₁-C₁₂-alkyl, C₂-C₁₂-hydroxyalkyl, C₂-C₁₂-alkenyl or C₆-C₁₂-aryl, or X,
R⁴ is C₁-C₁₂-alkyl, C₂-C₁₂-hydroxyalkyl, C₂-C₁₂-alkenyl or C₆-C₁₂-aryl
R⁵ is hydrogen, C₁-C₁₂-alkyl, C₂-C₁₂-hydroxyalkyl, C₂-C₁₂-alkenyl, C₁-C₁₂-acyl or C₆-C₁₂-aryl,
R⁶ is C₁-C₁₂-alkyl, C₂-C₁₂-hydroxyalkyl, C₂-C₁₂-alkenyl, C₁-C₁₂-acyl or C₆-C₁₂-aryl and
X is a carbonyl oxygen common to R² and R³,
   wherein R¹ and R⁴ and/or R⁵ and R⁶ can be a bridged C₂-C₆-alkanediyl and wherein the above mentioned radicals R¹ to R⁶ can still have in total one to two free valences and can be attached through these free valences to at least one suitable basic structure, for example 2-oxazolidones, such as 2-oxazolidone and N-hydroxyethyl-2-oxazolidone, N-hydroxypropyl-2-oxazolidone, N-methyl-2-oxazolidone, N-acyl-2-oxazolidones, such as N-acetyl-2-oxazolidone, 2-oxotetrahydro-1,3-oxazine, bicyclic amide acetals, such as 5-methyl-1-aza-4,6-dioxabicyclo[3.3.0]octane, 1-aza-4,6-dioxabicyclo[3.3.0]octane and 5-isopropyl-1-aza-4,6-dioxabicyclo[3.3.0]octane, bis-2-oxazolidones and poly-2-oxazolidones;
   or polyhydric alcohols, in which case the molecular weight of the polyhydric alcohol is preferably less than 100 g/mol, preferably less than 90 g/mol, more preferably less than 80 g/mol and most preferably less than 70 g/mol per hydroxyl group and the polyhydric alcohol has no vicinal, geminal, secondary or tertiary hydroxyl groups, and polyhydric alcohols are either diols of the general formula IIa

HO—R⁶—OH (IIa)

where R⁶ is either an unbranched dialkyl radical of the formula —(CH₂)ₘ—, where m is an integer from 3 to 20 and preferably from 3 to 12, and both the hydroxyl groups are terminal, or an unbranched, branched or cyclic dialkyl radical
or polyols of the general formula IIb

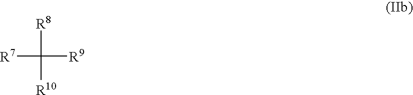

where R⁷, R⁸, R⁹ and R¹⁰ are independently hydrogen, hydroxyl, hydroxymethyl, hydroxyethyloxymethyl, 1-hydroxyprop-2-yloxymethyl, 2-hydroxypropyloxymethyl, methyl, ethyl, n-propyl, isopropyl, n-butyl, n-pentyl, n-hexyl, 1,2-dihydroxyethyl, 2-hydroxyethyl, 3-hydroxypropyl or 4-hydroxybutyl and in total 2, 3 or 4 and preferably 2 or 3 hydroxyl groups are present, and not more than one of R⁷, R⁸, R⁹ and R¹⁰ is hydroxyl, examples being 1,3-propanediol, 1,5-pentanediol, 1,6-hexanediol and 1,7-heptanediol, 1,3-butanediol, 1,8-octanediol, 1,9-nonanediol and 1,10-decanediol, butane-1,2,3-triol, butane-1,2,4-triol, glycerol, trimethylolpropane, trimethylolethane, pentaerythritol, glycerol each having 1 to 3 ethylene oxide units per molecule, trimethylolethane or trimethylolpropane each having 1 to 3 ethylene oxide units per molecule, propoxylated glycerol, trimethylolethane or trimethylolpropane each having 1 to 3 propylene oxide units per molecule, 2-tuply ethoxylated or propoxylated neopentylglycol,
or cyclic carbonates of the general formula III

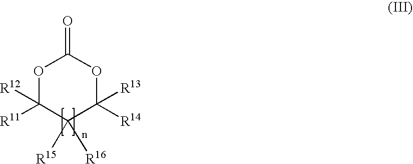

where R¹¹, R¹², R¹³, R¹⁴, R¹⁵ and R¹⁶ are independently hydrogen, methyl, ethyl, n-propyl, isopropyl, n-butyl, sec-butyl or isobutyl, and n is either 0 or 1, examples being ethylene carbonate and propylene carbonate,
or bisoxazolines of the general formula IV

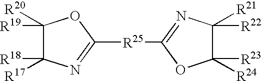

where R¹⁷, R¹⁸, R¹⁹, R²⁰, R²¹, R²², R²³ and R²⁴ are independently hydrogen, methyl, ethyl, n-propyl, isopropyl, n-butyl, sec-butyl or isobutyl and R²⁵ is a single bond, a linear, branched or cyclic C₁-C₁₂-dialkyl radical or polyalkoxydiyl radical which is constructed of one to ten ethylene oxide and/or propylene oxide units, and is comprised of by polyglycol dicarboxylic acids for example. An example for a compound under formula IV being 2,2′-bis(2-oxazoline).

The at least one post-crosslinker v) is typically used in an amount of about 1.50 wt. % or less, preferably not more than 0.50% by weight, more preferably not more than 0.30% by weight and most preferably in the range from 0.001% and 0.15% by weight, all percentages being based on the base polymer, as an aqueous solution. It is possible to use a single post-crosslinker v) from the above selection or any desired mixtures of various post-crosslinkers.

The aqueous post-crosslinking solution, as well as the at least one post-crosslinker v), can typically further comprise a cosolvent. Cosolvents which are technically highly useful are C₁-C₆-alcohols, such as methanol, ethanol, n-propanol, isopropanol, n-butanol, sec-butanol, tert-butanol or 2-methyl-1-propanol, C₂-C₅-diols, such as ethylene glycol, 1,2-propylene glycol, 1,3-propanediol or 1,4-butanediol, ketones, such as acetone, or carboxylic esters, such as ethyl acetate.

A preferred embodiment does not utilize any cosolvent. The at least one post-crosslinker v) is then only employed as a solution in water, with or without an added deagglomerating aid. Deagglomerating aids are known to one skilled in the art and are described for example in DE-A-10 239 074 and also prior German patent application 102004051242.6, which are each hereby expressly incorporated herein by reference. Preferred deagglomerating aids are surfactants such as ethoxylated and alkoxylated derivatives of 2-propylheptanol and also sorbitan monoesters. Particularly preferred deagglomerating aids are polyoxyethylene 20 sorbitan monolaurate and polyethylene glycol 400 monostearate.

The concentration of the at least one post-crosslinker v) in the aqueous post-crosslinking solution is for example in the range from 1% to 50% by weight, preferably in the range from 1.5% to 20% by weight and more preferably in the range from 2% to 5% by weight, based on the post-crosslinking solution.

In a further embodiment, the post-crosslinker is dissolved in at least one organic solvent and spray dispensed; in this case, the water content of the solution is less than 10 wt %, preferably no water at all is utilized in the post-crosslinking solution.

It is however understood that post-crosslinkers which effect comparable surface-crosslinking results with respect to the final polymer performance may of course be used in this invention even when the water content of the solution containing such post-crosslinker and optionally a cosolvent is anywhere in the range of >0 to <100% by weight.

The total amount of post-crosslinking solution based on the base polymer is typically in the range from 0.3% to 15% by weight and preferably in the range from 2% to 6% by weight. The practice of post-crosslinking is common knowledge to those skilled in the art and described for example in DE-A-12 239 074 and also prior German patent application 102004051242.6.

Spray nozzles useful for post-crosslinking are not subject to any restriction. Suitable nozzles and atomizing systems are described for example in the following literature references: Zerstäuben von Flüssigkeiten, Expert-Verlag, volume 660, Reihe Kontakt & Studium, Thomas Richter (2004) and also in Zerstäubungstechnik, Springer-Verlag, VDI-Reihe, Günter Wozniak (2002). Mono- and polydisperse spraying systems can be used. Suitable polydisperse systems include one-material pressure nozzles (forming a jet or lamellae), rotary atomizers, two-material atomizers, ultrasonic atomizers and impact nozzles. With regard to two-material atomizers, the mixing of the liquid phase with the gas phase can take place not only internally but also externally. The spray pattern produced by the nozzles is not critical and can assume any desired shape, for example a round jet, flat jet, wide angle round jet or circular ring. When two-material atomizers are used, the use of an inert gas will be advantageous. Such nozzles can be pressure fed with the liquid to be spray dispensed. The atomization of the liquid to be spray dispensed can in this case be effected by decompressing the liquid in the nozzle bore after the liquid has reached a certain minimum velocity. Also useful are one-material nozzles, for example slot nozzles or swirl or whirl chambers (full cone) nozzles (available for example from Düsen-Schlick GmbH, Germany or from Spraying Systems Deutschland GmbH, Germany). Such nozzles are also described in EP-A-0 534 228 and EP-A-1 191 051.

After spraying, the water-swellable polymeric particles are thermally dried, and the post-crosslinking reaction can take place before, during or after drying.

The spraying with the solution of post-crosslinker is preferably carried out in mixers having moving mixing implements, such as screw mixers, paddle mixers, disk mixers, plowshare mixers and shovel mixers. Particular preference is given to vertical mixers and very particular preference to plowshare mixers and shovel mixers. Useful mixers include for example Lödige® mixers, Bepex® mixers, Nauta® mixers, Processall® mixers and Schugi® mixers.

Contact dryers are preferable, shovel dryers are more preferable and disk dryers are most preferable as the apparatus in which thermal drying is carried out. Suitable dryers include for example Bepex dryers and Nara® dryers. Fluidized bed dryers can be used as well, an example being Carman® dryers.

Drying can take place in the mixer itself, for example by heating the jacket or introducing a stream of warm inert gases. It is similarly possible to use a downstream dryer, for example a tray dryer, a rotary tube oven or a heatable screw. But it is also possible for example to utilize an azeotropic distillation as a drying process.

It is particularly preferable to apply the solution of post-crosslinker in a high speed mixer, for example of the Schugi-Flexomix® or Turbolizer® type, to the base polymer and the latter can then be thermally post-crosslinked in a reaction dryer, for example of the Nara-Paddle-Dryer® type or a disk dryer (i.e. Torus-Disc Dryer®, Hosokawa). The temperature of the base polymer can be in the range from 10 to 120° C. from preceding operations, and the post-crosslinking solution can have a temperature in the range from 0 to 150° C. More particularly, the post-crosslinking solution can be heated to lower the viscosity. The preferred post-crosslinking and drying temperature range is from 30 to 220° C., especially from 120 to 210° C. and most preferably from 145 to 190° C. The preferred residence time at this temperature in the reaction mixer or dryer is preferably less than 100 minutes, more preferably less than 70 minutes and most preferably less than 40 minutes.

It is particularly preferable to utilize a fluidized bed dryer for the crosslinking reaction, and the residence time is then preferably below 30 minutes, more preferably below 20 minutes and most preferably below 10 minutes.

The post-crosslinking dryer or fluidized bed dryer may be operated with air or dried air to remove vapors efficiently from the polymer.

The post-crosslinking dryer is preferably purged with an inert gas during the drying and post-crosslinking reaction in order that vapors may be removed and oxidizing gases, such as atmospheric oxygen, may be displaced. The inert gas typically has the same limitations for relative humidity as described above for air. Mixtures of air and inert gases may also be used. To augment the drying process, the dryer and the attached assemblies are thermally well-insulated and ideally fully heated. The inside of the post-crosslinking dryer is preferably at atmospheric pressure, or else at a slight under- or overpressure. It is however also possible to do the drying and post-crosslinking reaction at low pressure or under vacuum conditions.

To produce a very white polymer, the gas space in the dryer is kept as free as possible of oxidizing gases; at any rate, the volume fraction of oxygen in the gas space is not more than 14% by volume.

The water-swellable polymeric particles can have a particle size distribution in the range from 45 μm to 4000 μm. Particle sizes used in the hygiene sector preferably range from 45 μm to 1000 μm, preferably from 45-850 μm, and especially from 100 μm to 850 μm. It is preferable to use water-swellable polymeric particles having a narrow particle size distribution, especially 100-850 μm, or even 100-600 μm

Narrow particle size distributions are those in which not less than 80% by weight of the particles, preferably not less than 90% by weight of the particles and most preferably not less than 95% by weight of the particles are within the selected range; this fraction can be determined using the familiar sieve method of EDANA 420.2-02 “Particle Size Distribution”. Selectively, optical methods can be used as well, provided these are calibrated against the accepted sieve method of EDANA.

Preferred narrow particle size distributions have a span of not more than 700 μm, more preferably of not more than 600 μm, and most preferably of less than 400 μm. Span here refers to the difference between the coarse sieve and the fine sieve which bound the distribution. The coarse sieve is not coarser than 850 μm and the fine sieve is not finer than 45 μm. Particle size ranges which are preferred for the purposes of the pre-sent invention are for example fractions of 150-600 μm (span: 450 μm), of 200-700 μm (span: 500 μm), of 150-500 μm (span: 350 μm), of 150-300 μm (span: 150 μm), of 300-700 μm (span: 400 μm), of 400-800 μm (span: 400 μm), of 100-800 μm (span: 700 μm).

Preference is likewise given to monodisperse water-swellable polymeric particles as obtained from the inverse suspension polymerization process. It is similarly possible to select mixtures of monodisperse particles of different diameter as water-swellable polymeric particles, for example mixtures of monodisperse particles having a small diameter and monodisperse particles having a large diameter. It is similarly possible to use mixtures of monodisperse with polydisperse water-swellable polymeric particles.

Preferred Processes for Making the Water-Swellable Material

The water-swellable material may be made by any known process. For the water-swellable material herein that comprise core-shell particles as described herein, it is preferred that fluidized bed reactors are used to apply the shell, include for example the fluidized or suspended bed coaters familiar in the pharmaceutical industry. Particular preference is given to the Wurster process and the Glatt-Zeller process and these are described for example in “Pharmazeutische Technologie, Georg Thieme Verlag, 2nd edition (1989), pages 412-413” and also in “Arzneiformenlehre, Wissenschaftliche Verlagsbuchandlung mbH, Stuttgart 1985, pages 130-132”. Particularly suitable batch and continuous fluidized bed processes on a commercial scale are described in Drying Technology, 20(2), 419-447 (2002).

In the Wurster process the water-swellable polymeric particles are carried by an upwardly directed stream of carrier gas in a central tube, against the force of gravity, past at least one spray nozzle and are sprayed concurrently with the finely disperse elastomeric polymer solution or dispersion. The particles thereafter fall back to the base along the side walls, are collected on the base, and are again carried by the flow of carrier gas through the central tube past the spray nozzle. The spray nozzle typically sprays from the bottom into the fluidized bed, it can also project from the bottom into the fluidized bed.

In the Glatt-Zeller process, the water-swellable polymeric particles are conveyed by the carrier gas on the outside along the walls in the upward direction and then fall in the middle onto a central nozzle head, which typically comprises at least 3 two-material nozzles which spray to the side. The particles are thus sprayed from the side, fall past the nozzle head to the base and are taken up again there by the carrier gas, so that the cycle can start anew.

The feature common to the two processes is that the water-swellable particles are repeatedly carried in the form of a fluidized bed past the spray device, whereby a very thin and typically very homogeneous shell can be applied. Furthermore, a carrier gas is used at all times and it has to be fed and moved at a sufficiently high rate to maintain fluidization of the particles. As a result, liquids are rapidly vaporized in the apparatus, such as for example the solvent (i.e. water) of the dispersion, even at low temperatures, whereby the elastomeric polymer particles of the dispersion are precipitated onto the surface of the particles of the water-swellable polymer. Useful carrier gases include the inert gases mentioned above and air or dried air or mixtures of any of these gases. Suitable fluidized bed reactors work—without wishing to be bound by theory—according to the principle that the elastomeric polymer solution or dispersion is finely atomized and the droplets randomly collide with the water-swellable polymer particles in a fluidized bed, whereby a substantially homogeneous shell builds up gradually and uniformly after many collisions. The size of the droplets must be inferior to the particle size of the absorbent polymer. Droplet size is determined by the type of nozzle, the spraying conditions i.e. temperature, concentration, viscosity, pressure and typical droplet sizes are in the range 10 μm to 400 μm. A polymer particle size vs. droplet size ratio of at least 10 is typically observed. Small droplets with a narrow size distribution are favourable. The droplets of the atomized elastomeric polymer dispersion or solution are introduced either concurrently with the particle flow or from the side into the particle flow, and may also be sprayed from the top onto a fluidized bed. In this sense, other apparatus and equipment modifications which comply with this principle and which are likewise capable of building up fluidized beds are perfectly suitable for producing such effects. The solution or dispersion of the elastomeric polymer applied by spray-coating is preferably very concentrated. For this, the viscosity of this solution or dispersion must not be too high, otherwise the solution or dispersion can no longer be finely dispersed by spraying. Preference is given to a solution or dispersion of the elastomeric polymer having a viscosity of <500 mPa·s, preferably of <300 mPa·s, more preferably of <100 mPa·s, even more preferably of <10 mPa·s, and most preferably <5 mPa·s (typically determined with a rotary viscometer at a shear rate ≧200 rpm and specifically suitable is a Haake rotary viscometer type RV20, system M5, NV).

One embodiment, for example, is a cylindrical fluidized bed batch reactor, in which the water-swellable polymer particles are transported upwards by a carrier-gas stream at the outer walls inside the apparatus and from one or more positions an elastomeric polymer spray is applied from the side into this fluidized bed, whereas in the middle zone of the apparatus, in which there is no carrier gas stream at all and where the particles fall down again, a cubic agitator is moving and redistributing the entire fluidized particle bed.

Other embodiments, for example, may be Schuggi mixers, turbolizers or plowshare mixers which can be used alone or preferably as a battery of plural consecutive units. If such a mixer is used alone, the water-swellable polymer may have to be fed multiple times through the apparatus to become homogeneously coated. If two or more of such apparatus are set up as consecutive units then one pass may be sufficient.

In another embodiment continuous or batch-type spray-mixers of the Telschig-type are used in which the spray hits free falling particles in-flight, the particles being repeatedly exposed to the spray. Suitable mixers are described in Chemie-Technik, 22 (1993), Nr. 4, p. 98 ff.

In a preferred embodiment, a continuous fluidized bed process is used and the spray is operated in top or bottom-mode. In a particularly preferred embodiment the spray is operated bottom-mode and the process is continuous. A suitable apparatus is for example described in U.S. Pat. No. 5,211,985. Suitable apparatus are available also for example from Glatt Maschinen-und Apparatebau AG (Switzerland) as series GF (continuous fluidized bed) and as ProCell® spouted bed. The spouted bed technology uses a simple slot instead of a screen bottom to generate the fluidized bed and is particularly suitable for materials which are difficult to fluidize.

In other embodiments it may also be desired to operate the spray top- and bottom-mode, or it may be desired to spray from the side or from a combination of several different spray positions.

The preferred process of the present invention utilizes the aforementioned nozzles, which are customarily used for post-crosslinking. However, two-material nozzles are particularly preferred.

The preferred process of the present invention preferably utilizes Wurster Coaters. Examples for such coaters are PRECISION COATERS™ available from GEAAeromatic Fielder AG (Switzerland) and are accessable at Coating Place Inc. (Wisconsin, USA).

It is advantageous that the fluidized bed gas stream which enters from below is likewise chosen such that the total amount of the water-swellable polymeric particles is fluidized in the apparatus. The gas velocity for the fluidized bed is above the minimum fluidization velocity (measurement method described in Kunii and Levenspiel “Fluidization engineering” 1991) and below the terminal velocity of water-swellable polymer particles, preferably 10% above the minimum fluidization velocity. The gas velocity for the Wurster tube is above the terminal velocity of water-swellable polymer particles, usually below 100 m/s, preferably 10% above the terminal velocity.

The gas stream acts to vaporize the water, or the solvents. In a preferred embodiment, the coating conditions of gas stream and temperature are chosen so that the relative humidity or vapor saturation at the exit of the gas stream is in the range from 10% to 90%, preferably from 10% to 80%, or preferably from 10% to 70% and especially from 30% to 60%, based on the equivalent absolute humidity prevailing in the carrier gas at the same temperature or, if appropriate, the absolute saturation vapor pressure.

The fluidized bed reactor may be built from stainless steel or any other typical material used for such reactors, also the product contacting parts may be stainless steel to accommodate the use of organic solvents and high temperatures.

In a further preferred embodiment, the inner surfaces of the fluidized bed reactor are at least partially coated with a material whose contact angle with water is more than 90° at 25° C. Teflon or polypropylene are examples of such a material. Preferably, all product-contacting parts of the apparatus are coated with this material.

The choice of material for the product-contacting parts of the apparatus, however, also depends on whether these materials exhibit strong adhesion to the utilized polymeric dispersion or solution or to the polymers to be coated. Preference is given to selecting materials which have no such adhesion either to the polymer to be coated or to the polymer dispersion or solution in order that caking may be avoided.

According to a preferred aspect of the present invention, coating takes place at a product and/or carrier gas temperature (for the entering carrier gas) in the range from 0° C. to 50° C., preferably at 5-45° C., especially 10-40° C. and most preferably 15-35° C.

The temperature of the carrier gas leaving the coating step is typically not higher than 100° C., preferably lower than 60° C., more preferably lower than 50° C., even more preferably lower than 45° C., and most preferably lower than 40° C., but not lower than 0° C.

In a preferred embodiment, a deagglomerating aid is added before the heat-treating step to the particles to be coated or preferably which have already been coated. A deagglomerating aid would be known by those skilled in the art to be for example a finely divided water-insoluble salt selected from organic and inorganic salts and mixtures thereof, and also waxes and surfactants. A water-insoluble salt refers herein to a salt which at a pH of 7 has a solubility in water of less than 5 g/l, preferably less than 3 g/l, especially less than 2 g/l and most preferably less than 1 g/l (at 25° C. and 1 bar). The use of a water-insoluble salt can reduce the tackiness due to the elastomeric polymer, especially the polyurethane which appears in the course of heat-treating.

The water-insoluble salts are used as a solid material or in the form of dispersions, preferably as an aqueous dispersion. Solids are typically jetted into the apparatus as fine dusts by means of a carrier gas. The dispersion is preferably applied by means of a high speed stirrer by preparing the dispersion from solid material and water in a first step and introducing it in a second step rapidly into the fluidized bed preferably via a nozzle. Preferably both steps are carried out in the same apparatus. The aqueous dispersion can if appropriate be applied together with the polyurethane (or other elastomeric polymer) or as a separate dispersion via separate nozzles at the same time as the polyurethane or at different times from the polyurethane. It is particularly preferable to apply the deagglomerating aid after the elastomeric polymer has been applied and before the subsequent heat-treating step.

Suitable cations in the water-insoluble salt are for example Ca²⁺, Mg²⁺, Al³⁺, Sc³⁺, Y³⁺, Ln³⁺ (where Ln denotes lanthanoids), Ti⁴⁺, Zr⁴⁺, Li⁺, K⁺, Na⁺ or Zn²⁺. Suitable inorganic anionic counterions are for example carbonate, sulfate, bicarbonate, orthophosphate, silicate, oxide or hydroxide. When a salt occurs in various crystal forms, all crystal forms of the salt shall be included. The water-insoluble inorganic salts are preferably selected from calcium sulfate, calcium carbonate, calcium phosphate, calcium silicate, calcium fluoride, apatite, magnesium phosphate, magnesiumhydroxide, magnesium oxide, magnesium carbonate, dolomite, lithium carbonate, lithium phosphate, zinc oxide, zinc phosphate, oxides, hydroxides, carbonates and phosphates of the lanthanoids, sodium lanthanoid sulfate, scandium sulfate, yttrium sulfate, lanthanum sulfate, scandium hydroxide, scandium oxide, aluminum oxide, hydrated aluminum oxide and mixtures thereof. Apatite refers to fluoroapatite, hydroxyl apatite, chloroapatite, carbonate apatite and carbonate fluoroapatite. Of particular suitability are calcium and magnesium salts such as calcium carbonate, calcium phosphate, magnesium carbonate, calcium oxide, magnesium oxide, calcium sulfate and mixtures thereof. Amorphous or crystalline forms of aluminum oxide, titanium dioxide and silicon dioxide are also suitable. These deagglomerating aids can also be used in their hydrated forms. Useful deagglomerating aids further include many clays, talcum and zeolites. Silicon dioxide is preferably used in its amorphous form, for example as hydrophilic or hydrophobic Aerosil®, but selectively can also be used as aqueous commercially available silica sol, such as for example Levasil® Kieselsole (H.C. Starck GmbH), which have particle sizes in the range 5-75 nm.

The average particle size of the finely divided water-insoluble salt is typically less than 200 μm, preferably less than 100 μm, especially less than 50 μm, more preferably less than 20 μm, even more preferably less than 10 μm and most preferably in the range of less than 5 μm. Fumed silicas are often used as even finer particles, e.g. less than 50 nm, preferably less than 30 nm, even more preferably less than 20 nm primary particle size.

In a preferred embodiment, the finely divided water-insoluble salt is used in an amount in the range from 0.001% to 20% by weight, preferably less than 10% by weight, especially in the range from 0.001% to 5% by weight, more preferably in the range from 0.001% to 2% by weight and most preferably between 0.001 and 1% by weight, based on the weight of the water-swellable polymer.

In lieu of or in addition to the above inorganic salts it is also possible to use other known deagglomerating aids, examples being waxes and preferably micronized or preferably partially oxidized polyethylenic waxes, which can likewise be used in the form of an aqueous dispersion. Such waxes are described in EP 0 755 964, which is hereby expressly incorporated herein by reference.

Useful deagglomerating aids further include stearic acid, stearates—for example: magnesium stearate, calcium stearate, zinc stearate, aluminum stearate, and furthermore polyoxyethylene-20-sorbitan monolaurate and also polyethylene glycol 400 monostearate.

Useful deagglomerating aids likewise include surfactants. A surfactant can be used alone or mixed with one of the abovementioned deagglomerating aids, preferably a water-soluble salt.

In general, the deagglomeration aid can be added before heat-treating. The surfactant can further be applied during the surface-post-crosslinking operation.

Useful surfactants include nonionic, anionic and cationic surfactants and also mixtures thereof. The water-swellable material preferably comprises nonionic surfactants. Useful nonionic surfactants include for example sorbitan esters, such as the mono-, di- or triesters of sorbitans with C₈-C₁₈-carboxylic acids such as lauric, palmitic, stearic and oleic acids; polysorbates; alkylpolyglucosides having 8 to 22 and preferably 10 to 18 carbon atoms in the alkyl chain and 1 to 20 and preferably 1.1 to 5 glucoside units; N-alkylglucamides; alkylamine alkoxylates or alkylamide ethoxylates; alkoxylated C₈-C₂₂-alcohols such as fatty alcohol alkoxylates or oxo alcohol alkoxylates; block polymers of ethylene oxide, propylene oxide and/or butylene oxide; alkylphenol ethoxylates having C₆-C₁₄-alkyl chains and 5 to 30 mol of ethylene oxide units.

The amount of surfactant is generally in the range from 0.01% to 0.5% by weight, preferably less than 0.1% by weight and especially below 0.05% by weight, based on the weight of the water-swellable polymer.

According to the invention, heat-treating takes preferably place at temperatures above 50° C., preferably in a temperature range from 100 to 200° C., especially 120-160° C. Without wishing to be bound by theory, the heat-treating causes the applied elastomeric polymer, preferably polyurethane, to flow and form a polymeric film whereby the polymer chains are entangled. The duration of the heat-treating is dependent on the heat-treating temperature chosen and the glass transition and melting temperatures of the elastomeric polymer. In general, a heat-treating time in the range from 30 minutes to 120 minutes will be found to be sufficient. However, the desired formation of the polymeric film can also be achieved when heat-treating for less than 30 minutes, for example in a fluidized bed dryer. Longer times are possible, of course, but especially at higher temperatures can lead to damage in the polymeric film or to the water-swellable material.

The heat-treating is carried out for example in a downstream fluidized bed dryer, a tunnel dryer, a tray dryer, one or more heated screws or a disk dryer or a Nara® dryer. Heat-treating is preferably done in a fluidized bed reactor and more preferably directly in the Wurster Coater.

The heat-treating can take place on trays in forced air ovens. In this case it is desirable to treat the coated polymer with a deagglomerating aid before heat-treating. Alternatively, the tray can be antistick coated and the coated polymer then placed on the tray as a monoparticulate layer in order that sintering together may be avoided.

In one embodiment for the process steps of coating, heat treating, and cooling, it may be possible to use air or dried air in each of these steps.

In other embodiments an inert gas may be used in one or more of these process steps.

In yet another embodiment one can use mixtures of air and inert gas in one or more of these process steps.

The heat-treating is preferably carried out under inert gas. It is particularly preferable that the coating step be carried out under inert gas as well. It is very particularly preferable when the concluding cooling phase is carried out under protective gas too. Preference is therefore given to a process where the production of the water-swellable material according to the present invention takes place under inert gas.

Imperfections in the homogeneity of the coating or shell may be made by adding fillers in the coating solution or dispersion. Such imperfections may be useful in certain embodiments of the invention.

After the heat-treating step has been concluded, the water-swellable material may be cooled. To this end, the warm and dry polymer is preferably continuously transferred into a downstream cooler. This can be for example a disk cooler, a Nara paddle cooler or a screw cooler. Cooling is via the walls and if appropriate the stirring elements of the cooler, through which a suitable cooling medium such as for example warm or cold water flows. Water or aqueous solutions or dispersions of additives may preferably be sprayed on in the cooler; this increases the efficiency of cooling (partial evaporation of water) and the residual moisture content in the finished product can be adjusted to a value in the range from 0% to 15% by weight, preferably in the range from 0.01% to 6% by weight and more preferably in the range from 0.1% to 3% by weight. The increased residual moisture content reduces the dust content of the water-swellable material and helps to accelerate the swelling when such material is contacted with aqueous liquids. Examples for additives are triethanolamine, surfactants, silica, or aluminumsulfate.

Optionally, however, it is possible to use the cooler for cooling only and to carry out the addition of water and additives in a downstream separate mixer. Cooling lowers the product temperature only to such an extent that the product can easily be packed in plastic bags or within silo trucks. Product temperature after cooling is typically less than 90° C., preferably less than 60° C., most preferably less than 40° C. and preferably more than −20° C.

It may be preferable to use a fluidized bed cooler.

If coating and heat-treating are both carried out in fluidized beds, the two operations can be carried out either in separate apparatus or in one apparatus having communicating chambers. If cooling too is to be carried out in a fluidized bed cooler, it can be carried out in a separate apparatus or optionally combined with the other two steps in just one apparatus having a third reaction chamber. More reaction chambers are possible as it may be desired to carry out certain steps like the coating step in multiple chambers consecutively linked to each other, so that the water absorbing polymer particles consecutively build the elastomeric polymer shell in each chamber by successively passing the particles through each chamber one after another.

Preference is given to a water-swellable material obtainable by a process comprising the steps of
a) spraying the water-swellable polymeric particles with a dispersion of an elastomeric polymer preferably at temperatures in the range from 0° C. to 50° C. and
b) optionally coating the particles obtained according to a), with a deagglomerating aid and subsequently
c) heat-treating the coated particles at a temperature above 50° C. and subsequently
d) cooling the heat-treated particles to below 90° C.

The elastomeric polymer especially the polyurethane can be applied as a solid material, as a hotmelt, as an organic dispersion, as an aqueous dispersion, as an aqueous solution or as an organic solution to the particles of the water-swellable polymers herein. The form in which the elastomeric polymer, especially the polyurethane is applied to the water-swellable polymeric particles is preferably as a solution or more preferably as an aqueous dispersion.

Useful solvents for polyurethanes include solvents which make it possible to establish 1 to not less than 40% by weight concentrations of the polyurethane in the respective solvent or mixture. As examples there may be mentioned alcohols, esters, ethers, ketones, amides, and halogenated hydrocarbons like methyl ethyl ketone, acetone, isopropanol, tetrahydrofuran, dimethylformamide, chloroform and mixtures thereof. Solvents which are polar, aprotic and boil below 100° C. are particularly advantageous.

Aqueous herein refers to water and also mixtures of water with up to 20% by weight of water-miscible solvents, based on the total amount of solvent. Water-miscible solvents are miscible with water in the desired use amount at 25° C. and 1 bar. They include alcohols such as methanol, ethanol, propanol, isopropanol, ethylene glycol, 1,2-propanediol, 1,3-propanediol, ethylene carbonate, glycerol and methoxyethanol.

### PROCESS EXAMPLE 1

### Coating of ASAP 510 Z Commercial Product with Permax 120

The 800-850 μm fraction was sieved out of the commercially available product ASAP 510 Z (BASF AG) having the following properties and was then coated with Permax 120.

ASAP 510 Z (properties before sieving):

### CRC=29.0 g/g

AUL 0.7 psi=24.5 g/g
SFC=50×10⁻⁷ [cm³s/g]

ASAP 510 Z (properties of the 800-850 μm fraction only):

### CS-CRC=32.5 g/g

CS-AUL 0.7 psi=26.4 g/g
CS-SFC=66×10⁻⁷ [cm³s/g]

A Wurster laboratory coater was used, the amount of water-swellable polymer (ASAP 510 Z in this case) used was 500 g, the Wurster tube was 50 mm in diameter and 150 mm in length, the gap width (distance from baseplate) was 15 mm, the Wurster apparatus was conical with a lower diameter of 150 mm expanding to an upper diameter of 300 mm, the carrier gas used was nitrogen having a temperature of 24° C., the gas speed was 3.1 m/s in the Wurster tube and 0.5 m/s in the surrounding annular space.

The elastomeric polymer dispersion was atomized using a nitrogen-driven two-material nozzle, opening diameter 1.2 mm, the nitrogen temperature being 28° C. The Permax 120 was sprayed from a 41% by weight neat aqueous dispersion whose temperature was 24° C., at a rate of 183 g of dispersion in the course of 65 min. In the process, 15% by weight of Permax was applied to the surface of the absorbent polymer. The amount reported is based on the water-swellable polymer used.

Two further runs were carried out in completely the same way except that the add-on level of the Permax was reduced: 5% by weight and 10% by weight.

The water-swellable material was subsequently removed and evenly distributed on Teflonized trays (to avoid sintering together) and dried in a vacuum cabinet at 150° C. for 2 hours. Clumps were removed by means of a coarse sieve (1000 μm) and the polymers were characterized as follows:

| Loading with | | CS-AUL 0.7 psi | CS-SFC |
|---|---|---|---|
| Permax 120 | CS-CRC [g/g] | [g/g] | [×10⁻⁷ cm³s/g]] |
| 5% by weight | 27.4 | 23.5 | 764 |
| 10% by weight | 23.1 | 22.0 | 1994 |
| 15% by weight | 21.5 | 20.2 | 2027 |

### EXAMPLE 2

### Coating of ASAP 510 Z Commercial Product with Permax 200

The 800-850 μm fraction was sieved out of the commercially available product ASAP 510 Z (BASF AG) having the following properties and was then coated with Permax 200 according to the present invention.

ASAP 510 Z (properties before sieving) as reported in Example 1.

A Wurster laboratory coater was used as in Example 1, the amount of water-swellable polymer (ASAP 510 Z in this case) used was 1000 g, the Wurster tube was 50 mm in diameter and 150 mm in length, the gap width (distance from baseplate) was 15 mm, the Wurster apparatus was conical with a lower diameter of 150 mm expanding to an upper diameter of 300 mm, the carrier gas used was nitrogen having a temperature of 24° C., the gas speed was 2.0 m/s in the Wurster tube and 0.5 m/s in the surrounding annular space.

The elastomeric polymer dispersion was atomized using a nitrogen-driven two-material nozzle, opening diameter 1.2 mm, the nitrogen temperature being 27° C. The Permax 200 was sprayed from a 22% by weight neat aqueous dispersion whose temperature was 24° C., at a rate of 455 g of dispersion in the course of 168 min. In the process, 10% by weight of Permax was applied to the surface of the absorbent polymer. The amount reported is based on the water-swellable polymer used.

Three further runs were carried out in completely the same way except that the add-on level of the Permax was reduced: 2.5% by weight, 5.0% by weight and 7.5% by weight. The water-swellable material was subsequently removed and evenly distributed on Teflonized trays (to avoid sintering together) and dried in a vacuum cabinet at 150° C. for 2 hours. Clumps were removed by means of a coarse sieve (1000 μm) and the polymers were characterized as follows:

| Loading with | | CS-AUL 0.7 psi | CS-SFC |
|---|---|---|---|
| Permax 200 | CS-CRC [g/g] | [g/g] | [×10⁻⁷ cm³s/g] |
| 2.5% by weight | 29.7 | 24.7 | 234 |
| 5.0% by weight | 27.5 | 25.3 | 755 |
| 7.5% by weight | 25.6 | 23.8 | 1082 |
| 10.0% by weight | 23.2 | 24.4 | 1451 |

### EXAMPLE 3

### Coating of ASAP 510 Z Commercial Product with Permax 200

The commercially available product ASAP 510 Z (BASF AG) having the following properties was used in the entirely commercially available particle size distribution of 150-850 μm and was then coated with Permax 200 according to the present invention.

ASAP 510 Z properties were as reported in Example 1.

A Wurster laboratory coater was used as in Examples 1 and 2, the amount of absorbent polymer (ASAP 510 Z in this case) used was 1000 g, the Wurster tube was 50 mm in diameter and 150 mm in length, the gap width (distance from baseplate) was 15 mm, the Wurster apparatus was conical with a lower diameter of 150 mm expanding to an upper diameter of 300 mm, the carrier gas used was nitrogen having a temperature of 24° C., the gas speed was 1.0 m/s in the Wurster tube and 0.26-0.30 m/s in the surrounding annular space.

The elastomeric polymer dispersion was atomized using a nitrogen-driven two-material nozzle, opening diameter 1.2 mm, the nitrogen temperature being 25° C. The Permax 200 was sprayed from a 22% by weight neat aqueous dispersion whose temperature was 24° C., at a rate of 455 g of dispersion in the course of 221 min. In the process, 10% by weight of Permax was applied to the surface of the absorbent polymer. The amount reported is based on the water-swellable polymer used.

Three further runs were carried out in completely the same way except that the add-on level of the Permax was reduced: 2.5% by weight, 5.0% by weight and 7.5% by weight.

The water-swellable material was subsequently removed and evenly distributed on Teflonized trays (to avoid sintering together) and dried in a vacuum cabinet at 150° C. for 2 hours. Clumps were removed by means of a coarse sieve (850 μm) and the polymers were characterized as follows:

| Loading with | | CS-AUL 0.7 psi | CS-SFC |
|---|---|---|---|
| Permax 200 | CS-CRC [g/g] | [g/g] | [×10⁻⁷ cm³s/g] |
| 2.5% by weight | 25.5 | 22.2 | 279 |
| 5.0% by weight | 24.1 | 25.1 | 735 |
| 7.5% by weight | 23.1 | 22.3 | 930 |
| 10.0% by weight | 21.7 | 25.4 | 1303 |

### EXAMPLE 4

### Use of a Deagglomerating Aid (Calcium Phosphate) Before Heat Treatment

The run of Example 2 with 10% of Permax 200 was repeated, however, the polymer coated with the dispersion was transferred to a laboratory tumble mixer and 1.0% by weight of tricalcium phosphate type C13-09 (from Budenheim, Mainz) based on polymer was added and mixed dry with the coated polymer for about 10 minutes. Thereafter the polymer was transferred into a laboratory fluidized bed dryer (diameter about 70 mm) preheated to 150° C. and, following a residence time of 30 minutes, the following properties were measured:

### CS-CRC=22.2 g/g

CS-AUL 0.7 psi=22.3 g/g
CS-SFC=1483×10⁻⁷ [cm³s/g]

There was no clumping whatsoever during the heat treatment in the fluidized bed, so that the fluidized bed remained very stable and as was demonstrated by subsequent sieving through a 1000 μm sieve.

A comparative run without addition of the deagglomerating aid led to disintegration of the fluidized bed and did not result in any useful product.

### EXAMPLE 5

### Use of a Deagglomerating Aid (Aerosil 90) Before Heat Treatment

The run of Example 2 with 10% of Permax 200 was repeated. However, the water-swellable material was transferred to a laboratory tumble mixer and 1.0% by weight Aerosil 90 (from Degussa) based on water-swellable material was added and mixed dry with the water-swellable material for about 10 minutes. Thereafter the polymer was placed in a layer of 1.5-2.0 cm in an open glass 5 cm in diameter and 3 cm in height and heat treated in a forced-air drying cabinet at 150° C. for 120 minutes. The material remained completely flowable, and did not undergo any caking or agglomeration.

The following properties were measured:

### CS-CRC=23.6 g/g

CS-AUL 0.7 psi=23.4 g/g
CS-SFC=1677×10⁻⁷ [cm³s/g]

### EXAMPLE 6

The run of Example 5 was repeated. However, no deagglomerating aid was added, but a 10 min homogenization was carried out in a tumble mixer. The particles were spread in a loose one-particle layer over a Teflonized tray and treated in a forced-air drying cabinet at 150° C. for 120 minutes.

The following properties were measured:

### CS-CRC=23.5 g/g

CS-AUL 0.7 psi=21.6 g/g
CS-SFC=1889×10⁻⁷ [cm³s/g]

Further examples to illustrate the present invention:

The Following is the Procedure to Make AM0127, as Used in the Examples Below:

Unless stated, all compounds are obtained by Merck, and used w/o purification.

To 2000 g of glacial acrylic acid (AA), an appropriate amount of the core crosslinker (e.g. 1.284 g MethyleneBisAcrylAmide, MAA, from Aldrich Chemicals) is added and allowed to dissolve at ambient temperature. An amount of water is calculated (6331 g) so that the total weight of all ingredients for the polymerization equals 10000 g (i.e. the concentration of AA is 20 w/w-%). 2000 mg of the initiator (“V50”=2,2′-azobis (N,N′-dimethyleneisobutyramidine) dihydrochloride, from Waco Chemicals) are dissolved in approx. 40 ml of this calculated amount of the deionized water. 1665.3 g of 50% NaOH are weighted out separately in a Teflon or plastic beaker.

A 16,000 ml resin kettle (equipped with a four-necked glass cover closed with septa, suited for the introduction of a thermometer, syringe needles) is charged with ˜5 kg ice (prepared from de-ionized water—the amount of this ice is subtracted from the amount of DI water above) Typically, a magnetic stirrer, capable of mixing the whole content (when liquid), is added. The 50% NaOH is added to the ice, and the resulting slurry is stirred. Then, the acrylic acid/MBAA is added within 1-2 minutes, while stirring is continued, and the remaining water is added. The resulting solution is clear, all ice melted, and the resulting temperature is typically 15-25° C. At this point, the initiator solution is added.

Then, the resin kettle is closed, and a pressure relief is provided e.g. by puncturing two syringe needles through the septa. The solution is then spurged vigorously with argon via a 60 cm injection needle while stirring at ˜600 RPM. Stirring is discontinued after ˜10 minutes, while argon spurging is continued, and two photo lamps (“Twinlite”) are placed on either side of the vessel. The solution typically starts to gel after 45-60 minutes total. At this point, persistent bubbles form on the surface of the gel, and the argon injection needle is raised above the surface of the gel. Purging with argon is continued at a reduced flow rate. The temperature is monitored; typically it rises from 20° C. to 60-70° C. within 60-90 minutes. Once the temperature drops below 60° C., the kettle is transferred into a circulation oven and kept at 60° C. for 15-18 hours.

After this time, the resin kettle is allowed to cool, and the gel is removed into a flat glass dish. The gel is then broken or cut with scissors into small pieces, and transferred into a vacuum oven, where it is dried at 100° C./maximum vacuum. Once the gel has reached a constant weight (usually 3 days), it is ground using a mechanical mill (e.g. IKA mill), and sieved to 150-850 μm. At this point, parameters as used herein may be determined.

(This Water-Swellable Polymer AM0127 Had No Post Crosslinking.)

The following are other water-swellable materials made by the process described above in example 3 and 4, respectively, using the conditions and material specified in the table (ASAP 510 being available from BASF):

| | | | | Conc. Of | | Max | |
|---|---|---|---|---|---|---|---|
| | Water- | Particle | | elastomeric | Coating | process | Coat |
| Water- | swellable | size | Elastomeric | polymer in | Level by | temp | time |
| swellable material | polymer | (um) | polymer | solvent | spraying | (° C.) | (min) |
| CP4-P120- | ASAP | 800-850 | Permax 120 | 41% water | 15% | 27.2 | 61.6 |
| 15% | 510Z | | | | | | |
| CP9-P200- | ASAP | 800-850 | Permax 200 | 22% water | 10% | 29.4 | 81.9 |
| 10% | 510Z | | | | | | |
| CP14-Xf-8.3% | ASAP | 800-850 | X-1007- | 5% THF | 8.30% | 32.8 | 99 |
| | 510Z | | 040P | | | | |
| CP16-P200- | ASAP | 150-850 | Permax 200 | 22% water | 10% | 28.3 | 86 |
| 10% | 510z | | | | | | |
| CP27-P200- | AM | 600-850 | Permax 200 | 22% water | 15% | 30.6 | 105 |
| 15%, 1% tri- | 0127 | | | | | | |
| calcium phosphate | | | | | | | |

The particle size distribution of the ASAP 510Z bulk material and the sieved fraction of ASAP510Z polymer particles with a particle size of 800-850 microns, 150-850 microns and 600-850 microns, as used above, is as follows:

| ASAP 510Z | | | ASAP 510z | |
|---|---|---|---|---|
| (bulk distribution) | | % | (800-850 μm) | % |
| <200 | μm | 7% | 400 μm | 4% |
| 250-300 | μm | 18% | 500 μm | 11% |
| 350-400 | μm | 33% | 600 μm | 25% |
| 500 | μm | 20% | 700 μm | 33% |
| 600 | μm | 12% | 800 μm | 25% |
| 700 | μm | 5% | TOTAL | 98% |
| 800 | μm | 2% | (mean: 700 μm) | |
| TOTAL | | 97% | | |
| ASAP510 | | | AM 0127 | |
| 150-850 μm | | % | 600-850 μm | % |
| 150 | μm | 1.7% | <600 μm | 1.98% |
| 200 | μm | 6.4% | 600 μm | 4.77% |
| 300 | μm | 11.3% | 700 μm | 49.11 |
| 400 | μm | 15.5% | 800 μm | 41.49 |
| 500 | μm | 16.6% | 850 μm | 2.63 |
| 600 | μm | 15.5% | | |
| 700 | μm | 21.1% | | |
| 800 | μm | 11.9% | | |

The materials obtained by the processes described above were submitted to the QUICs test, 4 hour CCRC test and CS-SFC test described herein and the values below were obtained. Also tested were some prior art materials, referred to as comparison water-swellable materials.

| | | | | | CS-SFC | |
|---|---|---|---|---|---|---|
| | Annealing | | | | 10\hat{ }-7 | |
| | conditions | SAC″ | QUICS | CCRC | cm3sec/g | ADI |
| Water-swellable material | | | | | | |
| of the invention: | | | | | | |
| CP4-P120-15%, ASAP510Z | 2 h 150° C. | 27.204 | 22.6 | 21.89 | 2324.2 | 5.88 |
| (800-850 μm) | | | | | | |
| CP9-P200-10%, ASAP510Z | 2 h 150° C. | 30.569 | 24.2 | 23.79 | 1727.2 | 6.63 |
| (800-850 μm) | | | | | | |
| CP14-Xf-8.3%, ASAP510Z | 2 h 150° C. | 29.122 | 32.0 | 21.60 | 1379.9 | 3.28 |
| (800-850 μm) | | | | | | |
| CP16-P200-10%, ASAP510Z | 2 h 150° C. | 27.276 | 20.0 | 23.47 | 1356.5 | 4.85 |
| (150-850 μm) | | | | | | |
| CP27-P200-15%, | 16 h 150° C./ | 63.822 | 77.5 | 34.05 | 276.3 | 9.99 |
| AM 0127 (600-850 μm) | 2 h 100° C. | | | | | |
| with the addition of | | | | | | |
| 1% Tricalcium phosphate | | | | | | |
| Comparison water- | | | | | | |
| swellable materials: | | | | | | |
| W 52521^{#} | 16 h 150° C./ | 24.278 | 3.5 | 22.95 | 189.0 | 0.6 |
| | 2 h 100° C. | | | | | |
| 6% Vector 4211 on | 2 h 150° C. | 37.98 | 12.9 | | | |
| ASAP500 Base Polymer^{##} | 16 h 150° C./ | 40.360 | 9.7 | | | |
| (1.6% VP654/6 on | 2 h 100° C. | | | | | |
| ASAP500 Base Polymer)^{###} | | | | | | |
| 6% Vector 4211 on | 2 h 150° C. | 35.018 | 10.6 | | | |
| ASAP500 Base Polymer^{##} | 16 h 150° C./ | 37.58 | 8.1 | | | |
| (1.6% VP654/6 on | 2 h 100° C. | | | | | |
| ASAP500 Base Polymer)^{###} | | | | | | |

^{#}W52521: water-swellable material, containing water-swellable polymer particles, available from Stockhausen.
^{##}water-swellable material as prepared in example 2.5 of co-pending application PCT application no. US2004/025836; “ASAP500 base polymer” available from BASF
^{###}water-swellable material as prepared in example 2.5 of co-pending application PCT application no. US2004/025836; “ASAP500 base polymer” available from BASF

Preparation of Films of the Elastic Polymer

In order to subject the elastic polymer used herein to some of the test methods below, films need to be obtained of said polymers.

The preferred average (as set out below) caliper of the (dry) films for evaluation in the test methods herein is around 60 μm.

Methods to prepare films are generally known to those skilled in the art and typically comprise solvent casting, hotmelt extrusion or melt blowing films. Films prepared by these methods may have a machine direction that is defined as the direction in which the film is drawn or pulled. The direction perpendicular to the machine direction is defined as the cross-direction.

For the purpose of the invention, the films used in the test methods below are formed by solvent casting, except when the elastic polymer cannot be made into a solution or dispersion of any of the solvents listed below, and then the films are made by hotmelt extrusion as described below. (The latter is the case when particulate matter from the elastic film-forming polymer is still visible in the mixture of the material or coating agent and the solvent, after attempting to dissolve or disperse it at room temperature for a period between 2 to 48 hours, or when the viscosity of the solution or dispersion is too high to allow film casting.)

The resulting film should have a smooth surface and be free of visible defects such as air bubbles or cracks.

An example to prepare a solvent cast film herein from an elastomeric polymer: The film to be subjected to the tests herein can be prepared by casting a film from a solution or dispersion of said polymer as follows:

The solution or dispersion is prepared by dissolving or dispersing the elastomeric polymer, at 10 weight %, in water, or if this is not possible, in THF (tetrahydrofuran), or if this is not possible, in dimethylformamide (DMF), or if this is not possible in methyl ethyl ketone (MEK), or if this is not possible, in dichloromethane or if this is not possible in toluene, or if this is not possible in cyclohexane (and if this is not possible, the hotmelt extrusion process below is used to form a film). Next, the dispersion or solution is poured into a Teflon dish and is covered with aluminum foil to slow evaporation, and the solvent or dispersant is slowly evaporated at a temperature above the minimum film forming temperature of the polymer, typically about 25° C., for a long period of time, e.g. during at least 48 hours, or even up to 7 days. Then, the films are placed in a vacuum oven for 6 hours, at 25° C., to ensure any remaining solvent is removed.

The process to form a film from an aqueous dispersions is as follows:

The dispersion may be used as received from the supplier, or diluted with water as long as the viscosity remains high enough to draw a film (200-500 cps). The dispersion solution (5-10 mL) is placed onto a piece of aluminum foil that is attached to the stage of the draw down table. The polymer dispersion is drawn using a Gardner metering rod #30 or #60 to draw a film that is 50-100 microns thick after drying. The dispersant is slowly evaporated at a temperature above the minimum film forming temperature of the polymer, typically about 25° C., for a long period of time, e.g. during at least 48 hours, or even up to 7 days. The film is heated in a vacuum oven at 150° C. for a minimum of 5 minutes up to 2 h, then the film is removed from the foil substrate by soaking in warm water bath for 5 to 10 min to remove the films from the substrate. The removed film is then placed onto a Teflon sheet and dried under ambient conditions for 24 h. The dried films are then sealed in a plastic bag until testing can be performed.

The process to prepare a hotmelt extruded film herein is as follows:

If the solvent casting method is not possible, films of the elastomeric polymer I herein may be extruded from a hot melt using a rotating single screw extrusion set of equipment operating at temperatures sufficiently high to allow the elastic film-forming polymer to flow. If the polymer has a melting temperature Tm, then the extrusion should take place at least 20 K above said Tm. If the polymer is amorphous (i.e. does not have a Tm), steady shear viscometry can be performed to determine the order to disorder transition for the polymer, or the temperature where the viscosity drops dramatically. The direction that the film is drawn from the extruder is defined as the machine direction and the direction perpendicular to the drawing direction is defined as the cross direction.

Heat-Treating of the Films:

The heat-treating of the films should, for the purpose of the test methods below, be done by placing the film in a vacuum oven at a temperature which is about 20 K above the highest Tg of the used elastic film-forming polymer, and this is done for 2 hours in a vacuum oven at less than 0.1 Torr, provided that when the elastic film-forming polymer has a melting temperature Tm, the heat-treating temperature is at least 20 K below the Tm, and then preferably (as close to) 20 K above the highest Tg. When the Tg is reached, the temperature should be increased slowly above the highest Tg to avoid gaseous discharge that may lead to bubbles in the film. For example, a material with a hard segment Tg of 70° C. might be heat-treated at 90° C. for 10 min, followed by incremental increases in temperature until the heat-treating temperature is reached.

If the elastic film-forming polymer has a Tm, then said heat-treating of the films (pre-pared as set out above and to be tested by the methods below) is done at a temperature which is above the (highest) Tg and at least 20 K below the Tm and (as close to) 20 K above the (highest) Tg. For example, a wet-extensible material that has a Tm of 135° C. and a highest Tg (of the hard segment) of 100° C., would be heat-treated at 115° C.

In the absence of a measurable Tg or Tm, the temperature for heat treating in this method is the same as used in the process for making water-absorbing material.

Removal of films, if applicable

If the dried and optionally heat-treated films are difficult to remove from the film-forming substrate, then they may be placed in a warm water bath for 30 s to 5 min to remove the films from the substrate. The film is then subsequently dried for 6-24 h at 25° C.

Wet-Tensile-Stress Test:

This test method is used to measure the wet-elongation at break (=extensibility at break) and tensile properties of films of elastomeric polymers as used herein, by applying a uniaxial strain to a flat sample and measuring the force that is required to elongate the sample. The film samples are herein strained in the cross-direction, when applicable.

A preferred piece of equipment to do the tests is a tensile tester such as a MTS Synergie100 or a MTS Alliance available from MTS Systems Corporation 14000 Technology Drive, Eden Prairie, Minn., USA, with a 25N or 50N load cell. This measures the Constant Rate of Extension in which the pulling grip moves at a uniform rate and the force measuring mechanisms moves a negligible distance (less than 0.13 mm) with increasing force. The load cell is selected such that the measured loads (e.g. force) of the tested samples will be between 10 and 90% of the capacity of the load cell.

Each sample is die-cut from a film, each sample being 1×1 inch (2.5×2.5 cm), as defined above, using an anvil hydraulic press die to cut the film into sample(s) (Thus, when the film is made by a process that does not introduce any orientation, the film may be tested in either direction.). Test specimens (minimum of three) are chosen which are substantially free of visible defects such as air bubbles, holes, inclusions, and cuts. They must also have sharp and substantially defect-free edges.

The thickness of each dry specimen is measured to an accuracy of 0.001 mm with a low pressure caliper gauge such as a Mitutoyo Caliper Gauge using a pressure of about 0.1 psi. Three different areas of the sample are measured and the average caliper is determined. The dry weight of each specimen is measured using a standard analytical balance to an accuracy of 0.001 g and recorded. Dry specimens are tested without further preparation for the determination of dry-elongation, dry-secant modulus, and dry-tensile stress values used herein.

For wet testing, pre-weighed dry film specimens are immersed in saline solution [0.9% (w/w) NaCl] for a period of 24 hours at ambient temperature (23+/−2° C.). Films are secured in the bath with a 120-mesh corrosion-resistant metal screen that prevents the sample from rolling up and sticking to itself. The film is removed from the bath and blotted dry with an absorbent tissue such as a Bounty® towel, to remove excess or non-absorbed solution from the surface. The wet caliper is determined as noted for the dry samples. Wet specimens are used for tensile testing without further preparation. Testing should be completed within 5 minutes after preparation is completed. Wet specimens are evaluated to determine wet-elongation, wet-secant modulus, and wet-tensile stress.

Tensile testing is performed on a constant rate of extension tensile tester with computer interface such as an MTS Alliance tensile tester with Testworks 4 software. Load cells are selected such that measured forces fall within 10-90% of the cell capacity. Pneumatic jaws, fitted with flat 1″-square rubber-faced grips, are set to give a gage length of 1 inch. The specimen is loaded with sufficient tension to eliminate observable slack, but less than 0.05N. The specimens are extended at a constant crosshead speed of 10″/min until the specimen completely breaks. If the specimen breaks at the grip interface or slippage within the grips is detected, then the data is disregarded and the test is repeated with a new specimen and the grip pressure is appropriately adjusted. Samples are run in triplicate to account for film variability.

The resulting tensile force-displacement data are converted to stress-strain curves using the initial sample dimensions from which the elongation, tensile stress, and modulus that are used herein are derived. The average secant modulus at 400% elongation is defined as the slope of the line that intersects the stress-strain curve at 0% and 400% strain. Three stress-strain curves are generated for each extensible film coating that is evaluated. The modulus used herein is the average of the respective values derived from each curve.

4 Hours Cylinder Centrifuge Retention Capacity (4 Hours CCRC)

The Cylinder Centrifuge Retention Capacity (CCRC) method determines the fluid retention capacity of the water-swellable materials or polymers (sample) after centrifugation at an acceleration of 250 g, herein referred to as absorbent capacity. Prior to centrifugation, the sample is allowed to swell in excess saline solution in a rigid sample cylinder with mesh bottom and an open top.

Duplicate sample specimens are evaluated for each material tested and the average value is reported.

The CCRC can be measured at ambient conditions, as set out in the QUICS test below, by placing the sample material (1.0+/−0.001 g) into a pre-weighed (+/−0.01 g) plexiglass sample container that is open at the top and closed on the bottom with a stainless steel mesh (400) that readily allows for saline flow into the cylinder but contains the absorbent particles being evaluated. The sample cylinder approximates a rectangular prism with rounded-edges in the 67 mm height dimension. The base dimensions (78×58 mm OD, 67.2×47.2 mM ID) precisely match those of modular tube adapters, herein referred to as the cylinder stand, which fit into the rectangular rotor buckets (Heraeus # 75002252, VWR # 20300-084) of the centrifuge (Heraeus Megafuge 1.0; Heraeus # 75003491, VWR # 20300-016).

The loaded sample cylinders are gently shaken to evenly distribute the sample across the mesh surface and then placed upright in a pan containing saline solution. The cylinders should be positioned to ensure free flow of saline through the mesh bottom. Cylinders should not be placed against each other or against the wall of the pan, or sealed against the pan bottom. The sample is allowed to swell, without confining pressure and in excess saline, for 4 hours.

After 4 hours, the cylinders are immediately removed from the solution. Each cylinder is placed (mesh side down) onto a cylinder stand and the resulting assembly is loaded into the rotor basket such that the two sample assemblies are in balancing positions in the centrifuge rotor.

The samples are centrifuged for 3 minutes (±10 s) after achieving the rotor velocity required to generate a centrifugal acceleration of 250±5 g at the bottom of the cylinder stand. The openings in the cylinder stands allow any solution expelled from the absorbent by the applied centrifugal forces to flow from the sample to the bottom of the rotor bucket where it is contained. The sample cylinders are promptly removed after the rotor comes to rest and weighed to the nearest 0.01 g.

The cylinder centrifuge retention capacity expressed as grams of saline solution absorbed per gram of sample material is calculated for each replicate as follows:

$$CCRC = \frac{{m}_{CS} - ( {m}_{Cb} + {m}_{S} )}{{m}_{S}} [ \frac{g}{g} ]$$

where:
m_{CS}: is the mass of the cylinder with sample after centrifugation [g]
m_{Cb}: is the mass of the dry cylinder without sample [g]
m_{S}: is the mass of the sample without saline solution [g]

The CCRC referred to herein is the average of the duplicate samples reported to the nearest 0.01 g/g.

Quality Index for Core Shells (QUICS): Method to Calculate the QUICS Value (QUICS Method):

The water-swellable material herein is such that it allows effective absorption of fluids, whilst providing at the same time a very good permeability of the water-swellable material, once it has absorbed the fluids and once it is swollen, as for example may be expressed in CS-SFC value, described herein.

The inventors found that the change of the absorbent capacity of water-swellable material when it is submitted to grinding, is a measure to determine whether the water-swellable material exerts a pressure, which is high enough to ensure a much improved permeability of the water-swellable material (when swollen) of the invention, providing ultimately an improved performance in use.

Preferably, the water-swellable material comprises particles with a core-shell structure described herein, whereby the shell of elastomeric polymers exerts said significant pressure onto said core of water-swellable polymers (whilst still allowing high quantities of fluid to be absorbed). The inventors have found that without such a shell, the water-swellable material may have a good fluid absorbent capacity, but it will have a very poor permeability, in comparison to the water-swellable material of the invention. Thus, the inventors have found that this internal pressure that is generated by the shell is beneficial for the ultimate performance of water-swellable material herein. Then, the change of the absorbent capacity of the water-swellable material, when the particles thereof are broken, e.g. when the shell on the particles (e.g. of the water-swellable polymers) is removed or destroyed, is a measure to determine whether the water-swellable material comprises particles with a shell that exerts a pressure onto the core, which is high enough to ensure a much improved permeability of the water-swellable material (when swollen) of the invention.

The following is the method used herein to determine the absorbent capacity of the water-swellable material, and the absorbent capacity of the same water-swellable material after submission to the grinding method (e.g. to destroy the shells), to subsequently determine the change of absorbent capacity, expressed as QUICS value.

As absorption fluid, a 0.9% NaCl solution in de-ionised water is used (‘saline’).

Each initial sample is 70 mg+/−0.05 mg water-swellable material of the invention (‘sample’).

Duplicate sample specimens are evaluated for each material tested and the average value is used herein.

a. Determination of the Saline Absorbent Capacity (SAC) of the Water-Swellable Material Sample

At ambient temperature and humidity (i.e. 20° C. and 50%+/−10% humidity) and at ambient pressure, the sample is placed into a pre-weighed (+/−0.01 g) Plexiglass sample container (QUICS-pot) that is open at the top and closed on the bottom with a stainless steel mesh (400) that readily allows for saline flow into the cylinder but contains the absorbent particles being evaluated. The sample cylinder approximates a rectangular prism with rounded-edges in the 67 mm height dimension. The base dimensions (78×58 mm OD, 67.2×47.2 mM ID) precisely match those of modular tube adapters, herein referred to as the cylinder stand, which fit into the rectangular rotor buckets (Heraeus # 75002252, VWR # 20300-084) of the centrifuge (Heraeus Megafuge 1.0; Heraeus # 75003491, VWR # 20300-016).

The cylinder with sample is gently shaken to evenly distribute the sample across the mesh surface and it is then placed upright in a pan containing saline solution. A second cylinder with a second sample is prepared in the same manner. The cylinders should be positioned such that to allow free flow of saline through the mesh bottom is ensured at all times. The cylinders should not be placed against each other or against the wall of the pan, or sealed against the pan bottom. Each sample is allowed to swell, at the ambient conditions above, without confining pressure, for 4 hours. The saline level inside the cylinders is at least 3 cm from the bottom mesh. Optionally, a small amount of a dye may be added to stain the (elastic) shell, e.g. 10 PPM Toluidine Blue, or 10 PPM Chicago Sky Blue 6B.

After 4 hours (+/−2 minutes), the cylinders are removed from the saline solution. Each cylinder is placed (mesh side down) onto a cylinder stand and the resulting assembly is loaded into the rotor basket of the centrifuge, such that the two sample assemblies are in balancing positions in the centrifuge rotor.

The samples are centrifuged for 3 minutes (±10 s) after achieving the rotor velocity required to generate a centrifugal acceleration of 250±5 g at the bottom of the cylinder stand. The openings in the cylinder stands allow any solution expelled from the absorbent by the applied centrifugal forces to flow from the sample to the bottom of the rotor bucket where it is contained. The sample cylinders are promptly removed after the rotor comes to rest and weighed to the nearest 0.01 g.

The Saline Absorbent Capacity (SAC) expressed as grams of 0.9 wt.-% saline solution absorbed per gram of sample material is calculated for each replicate as follows:

$$SAC = \frac{{m}_{CS} - ( {m}_{Cb} + {m}_{S} )}{{m}_{S}} [ \frac{g}{g} ]$$

where:
m_{CS}: is the mass of the cylinder with sample after centrifugation [g]
m_{Cb}: is the mass of the dry cylinder without sample [g]
m_{S}: is the mass of the sample without saline solution [g]

The SAC referred to herein is the average of the duplicate samples reported to the nearest 0.01 g/g.

b. Grinding of the Sample:

After the weight measurements above, the swollen sample obtained above is transferred (under the same temperature, humidity and pressure conditions as set out above) to the centre of a flat Teflon sheet (20*20 cm*1.0 mm) by means of a spatula. The Teflon sheet is supported on a hard, smooth surface, e.g. a standard laboratory bench. The QUICS-pot is weighed back to ensure that a >95% transfer of the swollen sample to the Teflon sheet has been achieved.

A round glass plate (15 cm diameter, 8 mm thickness) is added on top of the sample and the sample is thus squeezed between this top glass plate and the bottom support. Two 10 lbs weights are placed on the top glass plate; the top glass plate is rotated twice against the stationary Teflon sheet. (For example, when the water-swellable material comprises particles with shells, this operation will break or destroy the shell of the swollen particles of the swollen sample, and thus a (swollen) sample of broken particles, or typically particles with a broken or destroyed shell, are obtained.

c. Determination of the SAC″ of the Grinded (Swollen) Sample Obtained in 2. Above:

The grinded (swollen) sample obtained above in b) is quantitatively transferred back into the respective QUICS-pot, e.g. with the help of 0.9% NaCl solution from a squirt bottle, so that it is placed in the pot as described above. Each pot of each sample is placed in 0.9% NaCl solution under the same conditions and manner as above, but for 2 hours rather than 4 hours, and the second SAC″ of the sample is determined by the centrifugation described above.

N.B.: The time elapsed between the end of the first centrifugation to determine the SAC (in step a.) and the beginning of the step c. to determine the SAC″, (i.e. the start of transfer to QUICS pot), should not exceed more than 30 minutes.

d. QUICS Calculation:

Then the QUICS as used herein is determined as follows:

QUICS=100*(SAC″)/(SAC)−100

Glass Transition Temperatures

Glass Transition Temperatures (Tg's) are determined for the purpose of this invention by differential scanning calorimetry (DSC). The calorimeter should be capable of heating/cooling rates of at least 20° C./min over a temperature range, which includes the expected Tg's of the sample that is to be tested, e.g. of from −90° to 250° C., and the calorimeter should have a sensitivity of about 0.2 μW. TA Instruments Q1000 DSC is well-suited to determining the Tg's referred to herein. The material of interest can be analyzed using a temperature program such as: equilibrate at −90° C., ramp at 20° C./min to 120° C., hold isothermal for 5 minutes, ramp 20° C./min to −90° C., hold isothermal for 5 minutes, ramp 20° C./min to 250° C. The data (heat flow versus temperature) from the second heat cycle is used to calculate the Tg via a standard half extrapolated heat capacity temperature algorithm. Typically, 3-5 g of a sample material is weighed (+/−0.1 g) into an aluminum DSC pan with crimped lid.

Elastomeric Polymer Molecular Weights

Gel Permeation Chromatography with Multi-Angle Light Scattering Detection (GPCMALS) may be used for determining the molecular weight of the elastomeric polymers (e.g. of the shells herein). Molecular weights referred to herein are the weight-average molar mass (Mw). A suitable system for making these measurements consists of a DAWN DSP Laser Photometer (Wyatt Technology), an Optilab DSP Interferometric Refractometer (Wyatt Technology), and a standard HPLC pump, such as a Waters 600E system, all run via ASTRA software (Wyatt Technology).

As with any chromatographic separation, the choice of solvent, column, temperature and elution profiles and conditions depends upon the specific polymer which is to be tested. The following conditions have been found to be generally applicable for the elastomeric polymers referred to herein: Tetrahydrofuran (THF) is used as solvent and mobile phase; a flow rate of 1 mL/min is passed through two 300×7.5 mm, 5 μm, PLgel, Mixed-C GPC columns (Polymer Labs) which are placed in series and are heated to 40-45° C. (the Optilab refractometer is held at the same temperature); 100 μL of a 0.2% polymer solution in THF solution is injected for analysis. The dn/dc values are obtained from the literature where available or calculated with ASTRA utility. The weight-average molar mass (Mw) is calculated by with the ASTRA software using the Zimm fit method.

Moisture Vapor Transmission Rate Method (MVTR Method)

MVTR method measures the amount of water vapor that is transmitted through a film (e.g. of the shell material or elastomeric polymers described herein) under specific temperature and humidity. The transmitted vapor is absorbed by CaCl₂ desiccant and determined gravimetrically. Samples are evaluated in triplicate, along with a reference film sample of established permeability (e.g. Exxon Exxaire microporous material #XBF-110W) that is used as a positive control.

This test uses a flanged cup (machined from Delrin (McMaster-Carr Catalog #8572K34) and anhydrous CaCl₂ (Wako Pure Chemical Industries, Richmond, Va.; Catalog 030-00525). The height of the cup is 55 mm with an inner diameter of 30 mm and an outer diameter of 45 mm. The cup is fitted with a silicone gasket and lid containing 3 holes for thumb screws to completely seal the cup. Desiccant particles are of a size to pass through a No. 8 sieve but not through a No. 10 sieve. Film specimens approximately 1.5″×2.5″ that are free of obvious defects are used for the analysis. The film must completely cover the cup opening, A, which is 0.0007065 m².

The cup is filled with CaCl₂ to within 1 cm of the top. The cup is tapped on the counter 10 times, and the CaCl₂ surface is leveled. The amount of CaCl₂ is adjusted until the headspace between the film surface and the top of the CaCl2 is 1.0 cm. The film is placed on top of the cup across the opening (30 mm) and is secured using the silicone gasket, retaining ring, and thumb screws. Properly installed, the specimen should not be wrinkled or stretched. The sample assembly is weighed with an analytical balance and recorded to ±0.001 g. The assembly is placed in a constant temperature (40±3° C.) and humidity (75±3% RH) chamber for 5.0 hr±5 min. The sample assembly is removed, covered with Saran Wrap® and is secured with a rubber band. The sample is equilibrated to room temperature for 30 min, the plastic wrap removed, and the assembly is reweighed and the weight is recorded to ±0.001 g. The absorbed moisture Mₐ is the difference in initial and final assembly weights. MVTR, in g/m²/24 hr (g/m²/day), is calculated as:

MVTR=Mₐ/(A*0.208 day)

Replicate results are averaged and rounded to the nearest 100 g/m²/24 hr, e.g. 2865 g/m²/24 hr is herein given as 2900 g/m²/24 hr and 275 g/m²/24 hr is given as 300 g/m²/24 hr.

CRC (Centrifuge Retention Capacity)

This method determines the free swellability of the water-swellable material or polymer in a teabag. To determine CRC, 0.2000+/−0.0050 g of dried polymer or material (particle size fraction 106-850 μm or as specifically indicated in the examples which follow) is weighed into a teabag 60×85 mm in size, which is subsequently sealed shut. The teabag is placed for 30 minutes in an excess of 0.9% by weight sodium chloride solution (at least 0.83 l of sodium chloride solution/1 g of polymer powder). The teabag is subsequently centrifuged at 250 g for 3 minutes. The amount of liquid is determined by weighing the centrifuged teabag. The procedure corresponds to that of EDANA recommended test method No. 441.2-02 (EDANA=European Disposables and Nonwovens Association). The teabag material and also the centrifuge and the evaluation are likewise defined therein.

CS-CRC (Core Shell Centrifuge Retention Capacity)

CS-CRC is carried out completely analogously to CRC, except that the sample's swelling time is extended from 30 min to 240 min.

AUL (Absorbency Under Load 0.7 psi)

Absorbency Under Load is determined similarly to the absorption under pressure test method No. 442.2-02 recommended by EDANA (European Disposables and Nonwovens Association), except that for each example the actual sample having the particle size distribution reported in the example is measured.

The measuring cell for determining AUL 0.7 psi is a Plexiglas cylinder 60 mm in internal diameter and 50 mm in height. Adhesively attached to its underside is a stainless steel sieve bottom having a mesh size of 36 μm. The measuring cell further includes a plastic plate having a diameter of 59 mm and a weight which can be placed in the measuring cell together with the plastic plate. The weight of the plastic plate and the weight together weigh 1345 g. AUL 0.7 psi is determined by determining the weight of the empty Plexiglas cylinder and of the plastic plate and recording it as W₀. Then 0.900+/−0.005 g of water-swellable polymer or water-swellable material (particle size distribution 150-800 μm or as specifically reported in the examples which follow) is weighed into the Plexiglas cylinder and distributed very uniformly over the stainless steel sieve bottom. The plastic plate is then carefully placed in the Plexiglas cylinder, the entire unit is weighed and the weight is recorded as Wₐ. The weight is then placed on the plastic plate in the Plexiglas cylinder. A ceramic filter plate 120 mm in diameter, 10 mm in height and 0 in porosity (Duran, from Schott) is then placed in the middle of the Petri dish 200 mm in diameter and 30 mm in height and sufficient 0.9% by weight sodium chloride solution is introduced for the surface of the liquid to be level with the filter plate surface without the surface of the filter plate being wetted. A round filter paper 90 mm in diameter and <20 μm in pore size (S&S 589 Schwarzband from Schleicher & Schüll) is subsequently placed on the ceramic plate. The Plexiglas cylinder holding hydrogel-forming polymer is then placed with the plastic plate and weight on top of the filter paper and left there for 60 minutes. At the end of this period, the complete unit is taken out of the Petri dish from the filter paper and then the weight is removed from the Plexiglas cylinder. The Plexiglas cylinder holding swollen hydrogel is weighed out together with the plastic plate and the weight is recorded as W_{b}.

Absorbency under load (AUL) is calculated as follows:

AUL 0.7 psi [g/g]=[W_{b}−Wₐ]/[Wₐ−W₀]

AUL 0.3 psi and 0.5 psi are measured similarly at the appropriate lower pressure.

CS-AUL (Core Shell Absorption Under Load 0.7 psi)

The measuring cell for determining CS-AUL 0.7 psi is a Plexiglas cylinder 60 mm in internal diameter and 50 mm in height. Adhesively attached to its underside is a stainless steel sieve bottom having a mesh size of 36 μm (Steel 1.4401, wire diameter 0.028 mm, from Weisse & Eschrich). The measuring cell further includes a plastic plate having a diameter of 59 mm and a weight which can be placed in the measuring cell together with the plastic plate. The weight of the plastic plate and the weight together weigh 1345 g. AUL 0.7 psi is determined by determining the weight of the empty Plexiglas cylinder and of the plastic plate and recording it as W₀. Then 0.900+/−0.005 g of water-swellable material or polymer (particle size distribution 150-800 μm or as specifically reported in the example which follows) is weighed into the Plexiglas cylinder and distributed very uniformly over the stainless steel sieve bottom. The plastic plate is then carefully placed in the Plexiglas cylinder, the entire unit is weighed and the weight is recorded as Wₐ. The weight is then placed on the plastic plate in the Plexiglas cylinder. A round filter paper with a diameter of 90 mm (No. 597 from Schleicher & Schüll) is placed in the center of a 500 ml crystallizing dish (from Schott) 115 mm in diameter and 65 mm in height. 200 ml of 0.9% by weight sodium chloride solution are then introduced and the Plexiglas cylinder holding hydrogel-forming polymer is then placed with the plastic plate and weight on top of the filter paper and left there for 240 minutes. At the end of this period, the complete unit is taken out of the Petri dish from the filter paper and adherent liquid is drained off for 5 seconds. Then the weight is removed from the Plexiglas cylinder. The Plexiglas cylinder holding swollen hydrogel is weighed out together with the plastic plate and the weight is recorded as W_{b}.

Absorbency under load (AUL) is calculated as follows:

AUL 0.7 psi [g/g]=[W_{b}−Wₐ]/[Wₐ−W₀]

AUL 0.3 psi and 0.5 psi are measured similarly at the appropriate lower pressure.

Saline Flow Conductivity (SFC)

The method to determine the permeability of a swollen gel layer is the “Saline Flow Conductivity” also known as “Gel Layer Permeability” and is described in EP A 640 330. The equipment used for this method has been modified as described below.

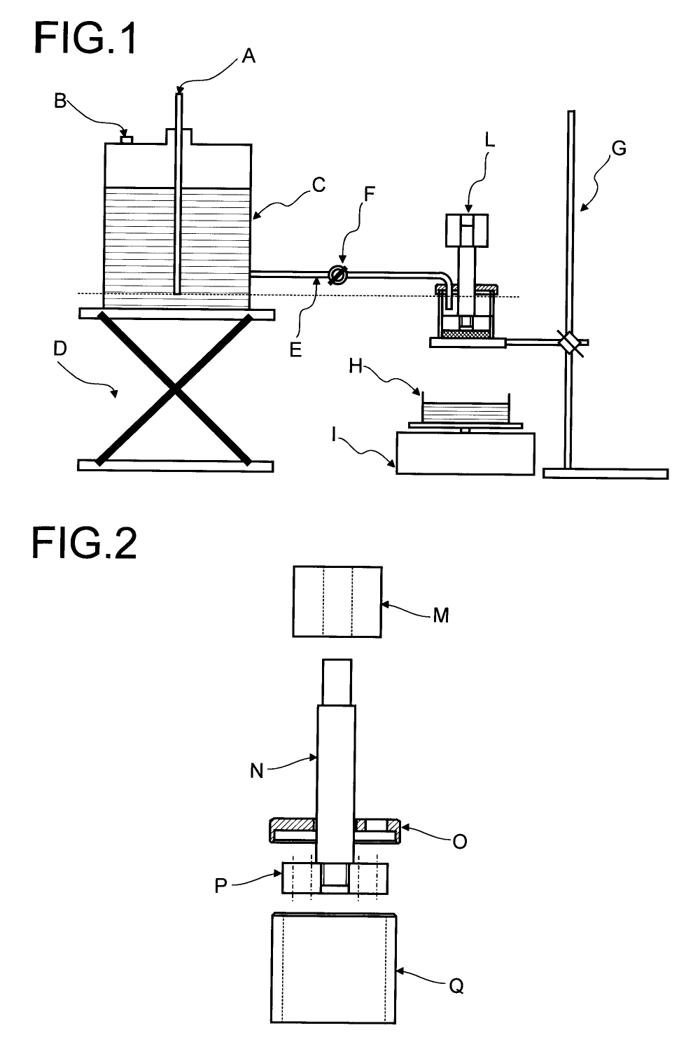

FIG. 1 shows the permeability measurement equipment set-up with the open-ended tube for air admittance A, stoppered vent for refilling B, constant hydrostatic head reservoir C, Lab Jack D, delivery tube E, stopcock F, ring stand support G, receiving vessel H, balance I and the SFC apparatus L.

FIG. 2 shows the SFC apparatus L consisting of the metal weight M, the plunger shaft N, the lid O, the center plunger P und the cylinder Q.

The cylinder Q has an inner diameter of 6.00 cm (area=28.27 cm²). The bottom of the cylinder Q is faced with a stainless-steel screen cloth (mesh width: 0.036 mm; wire diameter: 0.028 mm) that is bi-axially stretched to tautness prior to attachment. The plunger consists of a plunger shaft N of 21.15 mm diameter. The upper 26.0 mm having a diameter of 15.8 mm, forming a collar, a perforated center plunger P which is also screened with a stretched stainless-steel screen (mesh width: 0.036 mm; wire diameter: 0.028 mm), and annular stainless steel weights M. The annular stainless steel weights M have a center bore so they can slip on to plunger shaft and rest on the collar. The combined weight of the center plunger P, shaft and stainless-steel weights M must be 596 g (±6 g), which corresponds to 0.30 PSI over the area of the cylinder. The cylinder lid O has an opening in the center for vertically aligning the plunger shaft N and a second opening near the edge for introducing fluid from the reservoir into the cylinder Q.

The cylinder Q specification details are:

Outer diameter of the Cylinder: 70.35 mm
Inner diameter of the Cylinder: 60.0 mm

### Height of the Cylinder: 60.5 mm

The cylinder lid O specification details are:

Outer diameter of SFC Lid: 76.05 mm
Inner diameter of SFC Lid: 70.5 mm
Total outer height of SFC Lid: 12.7 mm
Height of SFC Lid without collar: 6.35 mm
Diameter of hole for Plunger shaft positioned in the center: 22.25 mm
Diameter of hole in SFC lid: 12.7 mm
Distance centers of above mentioned two holes: 23.5 mm

The metal weight M specification details are:

Diameter of Plunger shaft for metal weight: 16.0 mm
Diameter of metal weight: 50.0 mm
Height of metal weight: 39.0 mm

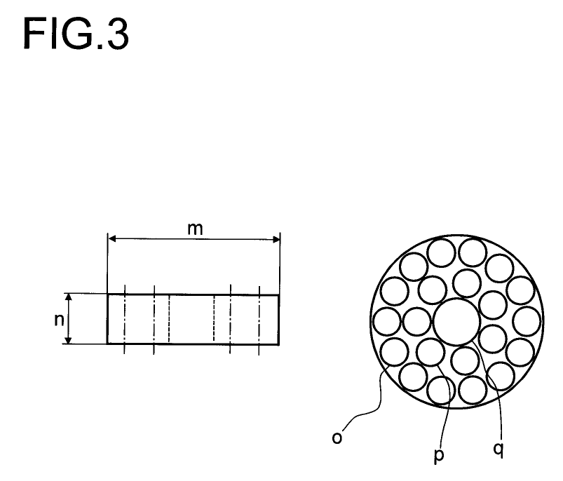

FIG. 3 shows the plunger center P specification details

Diameter m of SFC Plunger center: 59.7 mm
Height n of SFC Plunger center: 16.5 mm
14 holes o with 9.65 mm diameter equally spaced on a 47.8 mm bolt circle and 7 holes p with a diameter of 9.65 mm equally spaced on a 26.7 mm bolt circle ⅝ inches thread q

Prior to use, the stainless steel screens of SFC apparatus, should be accurately inspected for clogging, holes or over stretching and replaced when necessary. An SFC apparatus with damaged screen can deliver erroneous SFC results, and must not be used until the screen has been fully replaced.

Measure and clearly mark, with a permanent fine marker, the cylinder at a height of 5.00 cm (±0.05 cm) above the screen attached to the bottom of the cylinder. This marks the fluid level to be maintained during the analysis. Maintenance of correct and constant fluid level (hydrostatic pressure) is critical for measurement accuracy.

A constant hydrostatic head reservoir C is used to deliver NaCl solution to the cylinder and maintain the level of solution at a height of 5.0 cm above the screen attached to the bottom of the cylinder. The bottom end of the reservoir air-intake tube A is positioned so as to maintain the fluid level in the cylinder at the required 5.0 cm height during the measurement, i.e., the height of the bottom of the air tube A from the bench top is the same as the height from the bench top of the 5.0 cm mark on the cylinder as it sits on the support screen above the receiving vessel. Proper height alignment of the air intake tube A and the 5.0 cm fluid height mark on the cylinder is critical to the analysis. A suitable reservoir consists of a jar containing: a horizontally oriented L-shaped delivery tube E for fluid delivering, an open-ended vertical tube A for admitting air at a fixed height within the reservoir, and a stoppered vent B for re-filling the reservoir. The delivery tube E, positioned near the bottom of the reservoir C, contains a stopcock F for starting/stopping the delivery of fluid. The outlet of the tube is dimensioned to be inserted through the opening in the cylinder lid O, with its end positioned below the surface of the fluid in the cylinder (after the 5 cm height is attained). The air-intake tube is held in place with an o-ring collar. The reservoir can be positioned on a laboratory jack D in order to adjust its height relative to that of the cylinder. The components of the reservoir are sized so as to rapidly fill the cylinder to the required height (i.e., hydrostatic head) and maintain this height for the duration of the measurement. The reservoir must be capable to deliver liquid at a flow rate of minimum 3 g/sec for at least 10 minutes.

Position the plunger/cylinder apparatus on a ring stand with a 16 mesh rigid stainless steel support screen (or equivalent). This support screen is sufficiently permeable so as to not impede fluid flow and rigid enough to support the stainless steel mesh cloth pre-venting stretching. The support screen should be flat and level to avoid tilting the cylinder apparatus during the test. Collect the fluid passing through the screen in a collection reservoir, positioned below (but not supporting) the support screen. The collection reservoir is positioned on a balance accurate to at least 0.01 g. The digital output of the balance is connected to a computerized data acquisition system.

Preparation of Reagents

Following preparations are referred to a standard 1 liter volume. For preparation multiple than 1 liter, all the ingredients must be calculated as appropriate.

Jayco Synthetic Urine

Fill a 1 L volumetric flask with de-ionized water to 80% of its volume, add a stir bar and put it on a stirring plate. Separately, using a weighing paper or beaker weigh (accurate to ±0.01 g) the amounts of the following dry ingredients using the analytical balance and add them into the volumetric flask in the same order as listed below. Mix until all the solids are dissolved then remove the stir bar and dilute to 1 L volume with distilled water. Add a stir bar again and mix on a stirring plate for a few minutes more. The conductivity of the prepared solution must be 7.6±0.23 mS/cm.

### Chemical Formula Anhydrous Hydrated

### Potassium Chloride (KCl) 2.00 g

### Sodium Sulfate (Na₂SO₄) 2.00 g

Ammonium dihydrogen phosphate (NH₄H₂PO₄) 0.85 g
Ammonium phosphate, dibasic ((NH₄)₂HPO₄) 0.15 g

### Calcium Chloride (CaCl₂) 0.19 g (2H₂O) 0.25 g

Magnesium chloride (MgCl₂) 0.23 g (6H₂O) 0.50 g

To make the preparation faster, wait until total dissolution of each salt before adding the next one. Jayco may be stored in a clean glass container for 2 weeks. Do not use if solution becomes cloudy. Shelf life in a clean plastic container is 10 days.

0.118 M Sodium Chloride (NaCl) Solution

Using a weighing paper or beaker weigh (accurate to ±0.01 g) 6.90 g of sodium chloride into a 1 L volumetric flask and fill to volume with de-ionized water. Add a stir bar and mix on a stirring plate until all the solids are dissolved. The conductivity of the pre-pared solution must be 12.50±0.38 mS/cm.

Test Preparation

Using a reference metal cylinder (40 mm diameter; 140 mm height) set the caliper gauge (e.g. Mitotoyo Digimatic Height Gage) to read zero. This operation is conveniently performed on a smooth and level bench top. Position the SFC apparatus without water-swellable material or water-swellable polymer (‘sample’) under the caliper gauge and record the caliper as L1 to the nearest of 0.01 mm.

Fill the constant hydrostatic head reservoir with the 0.118 M NaCl solution. Position the bottom of the reservoir air-intake tube A so as to maintain the top part of the liquid meniscus in the SFC cylinder at the required 5.0 cm height during the measurement. Proper height alignment of the air-intake tube A at the 5 cm fluid height mark on the cylinder is critical to the analysis.

Saturate an 8 cm fritted disc (7 mm thick; e.g. Chemglass Inc. # CG 201-51, coarse porosity) by adding excess synthetic urine on the top of the disc. Repeating until the disc is saturated. Place the saturated fritted disc in the hydrating dish and add the synthetic urine until it reaches the level of the disc. The fluid height must not exceed the height of the disc.

Place the collection reservoir on the balance and connect the digital output of the balance to a computerized data acquisition system. Position the ring stand with a 16 mesh rigid stainless steel support screen above the collection dish. This 16 mesh screen should be sufficiently rigid to support the SFC apparatus during the measurement. The support screen must be flat and level.

Sampling

Samples should be stored in a closed bottle and kept in a constant, low humidity environment. Mix the sample to evenly distribute particle sizes. Remove a representative sample to be tested from the center of the container using the spatula. The use of a sample divider is recommended to increase the homogeneity of the sample particle size distribution.

SFC Procedure

Position the weighing funnel on the analytical balance plate and zero the balance. Using a spatula weigh 0.9 g (0.05 g) of the sample into the weighing funnel. Position the SFC cylinder on the bench, take the weighing funnel and gently, tapping with finger, transfer the sample into the cylinder being sure to have an evenly dispersion of it on the screen. During the sample transfer, gradually rotate the cylinder to facilitate the dispersion and get homogeneous distribution. It is important to have an even distribution of particles on the screen to obtain the highest precision result. At the end of the distribution the sample material must not adhere to the cylinder walls. Insert the plunger shaft into the lid central hole then insert the plunger center into the cylinder for few centimeters. Keeping the plunger center away from sample, insert the lid in the cylinder and carefully rotate it until the alignment between the two is reached. Carefully rotate the plunger to reach the alignment with lid then move it down allowing it to rest on top of the dry sample. Insert the stainless steel weight to the plunger rod and check if the lid moves freely. Proper seating of the lid prevents binding and assures an even distribution of the weight on the gel bed.

The thin screen on the cylinder bottom is easily stretched. To prevent stretching, apply a sideways pressure on the plunger rod, just above the lid, with the index finger while grasping the cylinder portion of the apparatus. This “locks” the plunger in place against the inside of the cylinder so that the apparatus can be lifted. Place the entire apparatus on the fritted disc in the hydrating dish. The fluid level in the dish should not exceed the height of the fritted disc. Care should be taken so that the layer does not loose fluid or take in air during this procedure. The fluid available in the dish should be enough for all the swelling phase. If needed, add more fluid to the dish during the hydration period to ensure there is sufficient synthetic urine available. After a period of 60 minutes, place the SFC apparatus under the caliper gauge and record the caliper as L2 to the nearest of 0.01 mm. Calculate, by difference L2−L1, the thickness of the gel layer as L0 to the nearest ±0.1 mm. If the reading changes with time, record only the initial value.

Transfer the SFC apparatus to the support screen above the collection dish. Be sure, when lifting the apparatus, to lock the plunger in place against the inside of the cylinder. Position the constant hydrostatic head reservoir such that the delivery tube is placed through the hole in the cylinder lid. Initiate the measurement in the following sequence:
a) Open the stopcock of the constant hydrostatic head reservoir and permit the fluid to reach the 5 cm mark. This fluid level should be obtained within 10 seconds of opening the stopcock.
b) Once 5 cm of fluid is attained, immediately initiate the data collection program.

With the aid of a computer attached to the balance, record the quantity of fluid passing through the gel layer versus time at intervals of 20 seconds for a time period of 10 minutes. At the end of 10 minutes, close the stopcock on the reservoir. The data from 60 seconds to the end of the experiment are used in the calculation. The data collected prior to 60 seconds are not included in the calculation. Perform the test in triplicate for each sample.

Evaluation of the measurement remains unchanged from EP-A 640 330. Through-flux is captured automatically.

Saline flow conductivity (SFC) is calculated as follows:

SFC [cm³s/g]=(Fg(t=0)×L₀)/(d×A×WP),

where Fg(t=0) is the through-flux of NaCl solution in g/s, which is obtained from a linear regression analysis of the Fg(t) data of the through-flux determinations by extrapolation to t=0, L₀ is the thickness of the gel layer in cm, d is the density of the NaCl solution in g/cm³, A is the area of the gel layer in cm² and WP is the hydrostatic pressure above the gel layer in dyn/cm².

CS-SFC (Core Shell Saline Flow Conductivity)

CS-SFC is determined completely analogously to SFC, with the following changes: To modify the SFC the person skilled in the art will design the feed line including the stopcock in such a way that the hydrodynamic resistance of the feed line is so low that prior to the start of the measurement time actually used for the evaluation an identical hydrodynamic pressure as in the SFC (5 cm) is attained and is also kept constant over the duration of the measurement time used for the evaluation.
the weight of sample used is 1.50+/−0.05 g
a 0.9% by weight sodium chloride solution is used as solution to preswell the sample and for through-flux measurement
the preswell time of the sample for measurement is 240 minutes
for preswelling, a filter paper 90 mm in diameter (Schleicher & Schüll, No 597) is placed in a 500 ml crystallizing dish (Schott, diameter=115 mm, height=65 mm) and 250 ml of 0.9% by weight sodium chloride solution are added, then the SFC measuring cell with the sample is placed on the filter paper and swelling is allowed for 240 minutes
the through-flux data are recorded every 5 seconds, for a total of 3 minutes
the points measured between 10 seconds and 180 seconds are used for evaluation and Fg(t=0) is the through-flux of NaCl solution in g/s which is obtained from a linear regression analysis of the Fg(t) data of the through-flux determinations by extrapolation to t=0.
the stock reservoir bottle in the SFC-measuring apparatus for through-flux solution contains about 5 L of sodium chloride solution.

Pulsed NMR Method to Determine Weight Percentage of the Shell

The following describes the method, which can be used to determine the weight percentage of the shell (by weight of the sample of the water-swellable material) of the water-swellable particles of said material, whereby said shell comprises elastomeric polymers with (at least one) Tg of less than 60° C., using known Pulsed Nuclear Magnetic Resonance techniques, whereby the size of each spin-echo signal from identical protons (bonded to the molecules of said elastomeric polymer present in a sample) is a measure of the amount of said protons present in the sample and hence a measure of the amount of said molecules of said elastomeric polymer present (and thus the weight percentage thereof—see below) present in the sample.

For the pulsed NMR measurement a Maran 23 Pulsed NMR Analyzer with 26 mm Probe, Universal Systems, Solon, Ohio, may be used.

The sample will be a water-swellable material, of which its chemical composition is know, and of which the weight percentage of the shell is to be determined.

To generate a calibration curve for needed for this measurement, water-swellable materials of the same chemical composition, but with known shell weight percentage levels are prepared as follows: 0% (no shell), 1%, 2%, 3%, 4%, 6%, 8% and 10% by weight. These are herein referred to as ‘standards’

Each standard and the sample must be vacuum dried for 24 h at 120° C. before the start of a measurement.

For each measurement, 5 grams (with an accuracy of 0.0001 g) of a standard or of a sample is weighed in a NMR tube (for example Glass sample tubes, 26 mm diameter, at least 15 cm in height).

The sample and the eight standards are placed in a mineral oil dry bath for 45 minutes prior to testing, said dry bath being set at 60° C.+/−1° C. (The bath temperature is verified by placing a glass tube containing two inches of mineral oil and a thermometer into the dry bath.) For example, a Fisher Isotemp. Dry Bath Model 145, 120V, 50/60 HZ, Cat. #11-715-100, or equivalent can be used.

The standards and the sample should not remain in the dry bath for more than 1 hour prior to testing. The sample and the standards must be analyzed within 1 minute after transfer from the bath to the NMR instrument.

For the NMR measurements, the NMR and RI Multiquant programs of the NMR equipment are started and the measurements are made following normal procedures (and using the exact shell amount [g] for each standard in the computer calculations). The centre of the spin echo data is used when analyzing the data, using normal procedures.

Then, the sample, prepared as above, is analyzed in the same manner and using the computer generated data regarding the standards, the weight percentage of the shell of the sample can be calculated.

Determination of the Shell Caliper and Shell Caliper Uniformity

The elastomeric shells on water-swellable polymers or particles thereof, as used herein, can typically be investigated by standard scanning electron microscopy, preferably environmental scanning electron microscopy (ESEM) as known to those skilled in the art. In the following method the ESEM evaluation is also used to determine the average shell caliper and the shell caliper uniformity, of the shells of the particles of the water-swellable materials herein, via cross-section of the particles.

Equipment model: ESEM XL 30 FEG (Field Emission Gun)

ESEM setting: high vacuum mode with gold covered samples to obtain also images at low magnification (35×) and ESEM dry mode with LFD (large Field Detector which detects ˜80% Gasous Secondary Electrons+20% Secondary Electrons) and bullet without PLA (Pressure Limiting Aperture) to obtain images of the shells as they are (no gold coverage required).

Filament Tension: 3 KV in high vacuum mode and 12 KV in ESEM dry mode. Pressure in Chamber on the ESEM dry mode: from 0.3 Torr to 1 Torr on gelatinous samples and from 0.8 to 1 Torr for other samples.

Each sample can be observed after about 1 hour at 20° C., 80% relative humidity using the standard ESEM conditions/equipment. Also a sample of a particle without shell can thus be observed, as reference. Then, the same samples can be observed in high vacuum mode. Then each sample can be cut via a cross-sectional cut with a teflon blade (Teflon blades are available from the AGAR scientific catalogue (ASSING) with reference code T5332), and observed again under vacuum mode.

The shells are clearly visible in the ESEM images, in particular when observing the cross-sectional views.

The average shell caliper is determined by analyzing at least 5 particles of the water-swellable material, comprising said shell, and determining 5 average calipers, one average per particle (and each of those averages is obtained by analyzing the cross-section of each particle and measuring the caliper of the shell in at least 3 different areas) and taking then the average of these 5 average calipers.

The uniformity of the shell is determined by determining the minimum and maximum caliper of the shell via ESEM of the cross-sectional cuts of at least 5 different particles and determining the average (over 5) minimum and average maximum caliper and the ratio thereof.

If the shell is not clearly visible in ESEM, then staining techniques known to the skilled in the art that are specific for the shell applied may be used such as enhancing the contrast with osmium tetraoxide, potassium permanganate and the like, e.g. prior to using the ESEM method.

Possible Method to Determine the Theoretical Equivalent Shell Caliper of the Particles of the Water-Swellable Material Herein

If the weight level of the shell comprised in the water-swellable material is known, a theoretical equivalent average shell caliper may be determined as defined below.

This method calculates the average shell caliper of a shell on the particle cores of the water-swellable material herein, under the assumption that the water-swellable material is to be monodisperse and spherical (which may not be the case in practice).

Key Parameters

| INPUT Parameter | Symbol |
|---|---|
| Mass Median Particle Size of the water-swellable polymer | D_AGM_dry |
| (AGM) without shell (e.g prior to applying the shell; also called | |
| “average diameter”) | |
| Intrinsic density of the base water-swellable bulk polymer (without | Rho_AGM_intrinsic |
| shell) | |
| Intrinsic density of the material (e.g. elastomeric polymer) of the | Rho_polymer shell |
| shell only | |
| Shell Weight Fraction of the water-swellable material ( | c_shell_per_total |
| OUTPUT Parameters | |
| Average shell caliper if the water-swellable material is mono- | d_shell |
| disperse and spherical | |
| Mass Median Particle Size of the particles of the water- | D_AGM_coated |
| swellable material with shells on its particles (“average diameter | |
| when shell present”) | |
| Weight Ratio as of weight of shell per weight of water-swellable | c_shell_to_bulk |
| material without shell | |

Formulas

(note: in this notation: all c which are in percent have ranges of 0 to 1 which is equivalent to 0 to 100%.)

$$d\_shell := \frac{D\_AGM \_dry}{2} \cdot [ {[ \begin{matrix}1 + \frac{c\_shell \_per \_total}{( 1 - c\_shell \_per \_total )} \cdot \\ \frac{Rho\_AGM \_intrinsic}{Rho\_polymer \_shell}\end{matrix} ]}^{\frac{1}{3}} - 1 ]$$

$$D\_coated \_AGM := D\_AGM \_dry + 2 \cdot d\_shell$$

$$c\_shell \_to \_bulk := \frac{c\_shell \_per \_total}{1 - c\_shell \_per \_total}$$

Example

D_AGM_dry:=0.4 mm (400 μm); Rho_AGM_intrinsic:=Rho_polymer_shell:=1.5 g/cc

| | | | | | | | | |
|---|---|---|---|---|---|---|---|---|
| C_shell_per_total [%] | 1 | 2 | 5 | 10 | 20 | 30 | 40 | 50 |
| C_shell_to_bulk [%] | 1.0 | 2.0 | 5.3 | 11 | 25 | 43 | 67 | 100 |
| d_shell [μm] | 0.7 | 1.4 | 3.4 | 7.1 | 15 | 25 | 37 | 52 |
| D_Coated_AGM [μm] | 401 | 403 | 407 | 414 | 431 | 450 | 474 | 504 |

Free Swell Rate (FSR)

1.00 g (=W1) of the dry water-swellable material or polymer particles is weighed into a 25 ml glass beaker and is uniformly distributed on the base of the glass beaker. 20 ml of a 0.9% by weight sodium chloride solution are then dispensed into a second glass beaker, the contents of this beaker are rapidly added to the first beaker and a stopwatch is started. As soon as the last drop of salt solution is absorbed, confirmed by the disappearance of the reflection on the liquid surface, the stopwatch is stopped. The exact amount of liquid poured from the second beaker and absorbed by the polymer in the first beaker is accurately determined by weighing back the second beaker (═W2). The time needed for the absorption, which was measured with the stopwatch, is denoted t. The disappearance of the last drop of liquid on the surface is defined as time t.

The free swell rate (FSR) is calculated as follows:

FSR [g/gs]=W2/(W1xt)

When the moisture content of the water-swellable material or polymer is more than 3% by weight, however, the weight W1 must be corrected for this moisture content.

Surface Tension of Aqueous Extract

0.50 g of the water-swellable material or polymeric particles is weighed into a small glass beaker and admixed with 40 ml of 0.9% by weight salt solution. The contents of the beaker are magnetically stirred at 500 rpm for 3 minutes and then allowed to settle for 2 minutes. Finally, the surface tension of the supernatant aqueous phase is measured with a K10-ST digital tensiometer or a comparable apparatus having a platinum plate (from Kruess). The measurement is carried out at a temperature of 23° C.

Moisture Content of Base Polymer

The water content of the water-swellable material or polymers is determined by the EDANA (European Disposables and Nonwovens Association) recommended test method No. 430.2-02 “Moisture content”.

CIE Color Number (L a b)

Color measurement was carried out in accordance with the CIELAB procedure (Hunterlab, volume 8, 1996, issue 7, pages 1 to 4). In the CIELAB system, the colors are described via the coordinates L*, a* and b* of a three-dimensional system. L* indicates lightness, with L*=0 denoting black and L*=100 denoting white. The a* and b* values indicate the position of the color on the color axes red/green and yellow/blue respectively, where +a* represents red, −a* represents green, +b* represents yellow and −b* represents blue.

The color measurement complies with the three-range method of German standard specification DIN 5033-6.

The Hunter 60 value is a measure of the whiteness of surfaces and is defined as L*−3b*, i.e. the lower the value, the darker and the yellower the color is.

A Hunterlab LS 5100 Colorimeter was used.

The EDANA test methods are obtainable for example at European Disposables and Nonwovens Association, Avenue Eugène Plasky 157, B-1030 Brussels, Belgium.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1-14. (canceled)

15. A water-swellable material comprising particles comprising a core and a shell, wherein said core comprises water-swellable polymers and said shell comprises at least one elastomeric polymer, wherein said water-swellable material has (1) an absorbent capacity of at least about 20 g/g, as measured in the 4-hour CCRC test; (2) a Saline Absorbent Capacity (SAC); a (3) Saline Absorbent Capacity after grinding (SAC″); and (4) a QUICS value calculated therefrom, wherein said QUICS value is at least 15.

16. The water-swellable material of claim 15, wherein said QUICS value is less than 200.

17. A water-swellable material comprising water-swellable polymers, wherein said water-swellable material has (1) an absorbent capacity of at least about 20 g/g, as measured in the 4-hour CCRC test; (2) a SAC; a (3) SAC″; and a QUICS value calculated therefrom, wherein said QUICS value is more than (5/3)+SAC″×(5/12).

18. The water-swellable material of claim 17, wherein said QUICS value is greater than 10 and said water-swellable material comprises at least one polyetherpolyurethane elastomeric polymers, wherein said at least one polyetherpolyurethane elastomeric polymers comprises at least one main chain and/or side chains with alkylene oxide units.

19. A water-swellable material comprising water-swellable polymer particles, wherein said water-swellable material has (1) an absorbent capacity of at least about 20 g/g, as measured in the 4-hour CCRC test; (2) a (SAC); a SAC″; and a QUICS value calculated therefrom, wherein said water-swellable material is obtained by a process of
a) spray-coating said water-swellable polymeric particles with an elastomeric polymer at temperatures in the range of from 0° C. to 50° C.; and
b) heat-treating said coated particles at a temperature above 50° C.; wherein said water-swellable material has a QUICS value greater than 10.

20. The water-swellable material of claim 15, wherein said QUICS value is at least 20.

21. The water-swellable material of claim 20, wherein said QUICS value is 100 or less.

22. The water-swellable material of claim 15, wherein said water-swellable material has a CS-SFC value of at least about 10×10⁻⁷ cm³ s/g.

23. The water-swellable material of claim 22, wherein said water-swellable material has a CS-SFC value of at least 500×10⁻⁷ cm³ s/g.

24. The water-swellable material of claim 15, wherein said water-swellable material comprises water-swellable particles comprising a core and a shell, wherein said core comprises water-swellable polymer(s) and said shell comprises at least one elastomeric polymer, wherein said at least one elastomeric polymer is a polyetherpolyurethane and wherein at least one main chain and/or side chains of said polyetherpolyurethane comprises alkylene oxide units.

25. The water-swellable material of claim 24, wherein a main chain of said polyetherpolyurethane comprises alkylene oxide units and/or side chains of said polyetherpolyurethane comprises ethylene oxide units.

26. The water-swellable material of claim 25, wherein said water-swellable polymers are post-cross-linked and said shells have an average shell tension of from 15 N/m to 60 N/m.

27. The water-swellable material of claim 24, wherein said shells have an average shell tension of from 20 to 60N/m.

28. The water-swellable material of claim 24, wherein said water-swellable polymers are not post-cross-linked and said shells have an average shell tension of greater than 60 N/m.

29. The water-swellable material of claim 15, wherein said water-swellable material has an Absorbency Distribution Index of greater than 1.

30. The water-swellable material of claim 29, wherein said water-swellable material has an Absorbency Distribution Index of at least 6.

31. The water-swellable material of claim 29, wherein said water-swellable material has an Absorbency Distribution Index of 50 or less.

32. A process for preparing the water-swellable material of claim 15, said water-swellable material comprising a shell of elastomeric polymer(s) on a core of water-swellable polymer particles, said process comprising
a) spray-coating water-swellable polymeric particles with an elastomeric polymer at temperatures in the range of from 0° C. to 50° C.; and
b) heat-treating said coated particles at a temperature above 50° C.

33. The process of claim 32, whereby a) is performed in a fluidized bed reactor and said elastomeric polymer is sprayed on said water-swellable polymeric particles in the form of a dispersion or solution, said dispersion or solution preferably having a viscosity of less than 500 mPa·s.

34. The process of claim 33, wherein said dispersion or solution has a viscosity of less than 500 mPa·s.
